(19) United States
(12) Patent Application Publication
(10) Pub. No.: US 2006/0117307 A1
(43) Pub. Date: Jun. 1, 2006

(54) XML parser

(75) Inventors: Amir Averbuch, Tel Aviv (IL); Shachar Harussi, Kfar Haoranim (IL); Amiram Yehudai, Tel Aviv (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: RAMOT AT TEL-AVIV UNIVERSITY LTD.

(21) Appl. No.: 10/995,191

(22) Filed: Nov. 24, 2004

(51) Int. Cl. G06F 9/45

(52) U.S. Cl. 717/143

(57) ABSTRACT

A method of generating a parser of a source code file that references a syntactic dictionary, a method of compressing the file, and apparatuses that use the methods. The syntactic dictionary is converted into a corresponding plurality of expressions, of a context-free grammar, that are a grammar of the source code. The parser is constructed from the expressions. The source code is compressed using the parser. Preferably, the grammar of the source code file is a D-grammar and the expressions are regular expressions. Preferably, the parser is a deterministic pushdown transducer. An important case of the present invention is that in which the source code is XML code and the syntactic dictionary is the document type declaration of the XML code. Apparatuses that use a parser of the present invention include compressors, decompressors, validators, converters, editors, network devices and end-user/hand-held devices.

### FIELD OF THE INVENTION

The present invention relates to manipulation of source code and, more particularly, to a parser for languages such as XML whose source code files include, or refer to, syntactic dictionaries.

As the World Wide Web transitions from just being a medium for browsing to a medium for commerce, web services, and application integration, XML (extensible Markup Language) has emerged as the standard language for markup. Multiple applications over the Internet are increasingly adopting XML as the standard for expressing messages, schema, and data. Consequently, XML is the de facto standard for Web based applications such as e-commerce using Simple Object Access Protocol (SOAP).

Several problems arise as a result. First of all, with the rapidly increasing volume of XML data being exchanged for information purposes and for conducting business, the bandwidth of networks and other communication channels is being tested to its limit. Traditional algorithms for processing source code do not assume any knowledge of the document syntactic or semantic structure. In the case of XML documents, such knowledge provides additional opportunities for XML processing.

In another area of XML applications, XML documents are stored and saved, then searched and retrieved. Besides the size and time efficiency in compressing and decompressing the whole document, the preservation of the document structural information becomes really important. It allows applications to do efficient searches and retrieve parts of documents rather than whole documents. Traditional compression systems do not retain this structural information of the documents.

In the related area of XML applications, XML documents are passed from application to application while being manipulated in each application separately. This manipulation needs to be efficient. Typically, an application, that receives an XML document as an input, manipulates the XML data: either by using data object model (DOM) to access an in-memory tree representation of the XML document produced by an XML parser, or by building its own representation of the document or its parts based on the parsing events passed by the XML parser to the application. Current DOM representations of XML documents are, in most cases, quite expensive size-wise. In addition, as a result of the large size, manipulations that require copying and moving subtrees of a DOM tree are also expensive performance-wise.

Thus there is a need to have an XML parser and XML compression and streaming systems that work efficiently in the Internet or direct communication context for the application domains described above. The present invention addresses these needs

### BACKGROUND OF THE INVENTION

### XML

The evolution of XML is a search for a format which has a syntax that can be easily processed by computers, and which is extensible enough to describe the dynamic variety of WEB contents. Over three decades ago, IBM developed the Generalized Markup Language (GML) for its big internal publishing archiving. GML is designed so the same source files could be processed to produce books, reports, and electronic editions. GML has an easy syntax for humans to read. It defines a tags set. A tag is a string delimited by angle brackets. The tags instruct the user how to format the text. The problem of GML is that it is not well suited for computer applications. The Standardized Generalized Markup Language (SGML) was designed to be processed by computers and is as extensible as GML. Its extensibility is achieved by a Document Type Definition (DTD) which describes tag sets for different SGML document types. But SGML parsing is still complicated. Hyper Text Markup Language (HTML) was the next step of evolution. HTML is the first WEB documents descriptive language. It defines a fixed subset of SGML tags which have a representative meaning. This restriction makes it easy to be parsed by WEB browsers but damages its extensibility. A single tag set is not sufficient for all of the kinds of information on the WEB. Extensible Markup Language (XML) address the engineering complexity of SGML and the limitations of the fixed tag set in HTML. XML is a restricted form of SGML. The simplifications in XML do not detract from XML's extensibility, but make it easier for a computer to process.

XML's main use is a reformulation of a version of HTML as XML (XHTML). The XTHML document illustrated in FIGS. 2A and 2B is used herein to demonstrate our encoding concepts. FIG. 2A shows the textual XML syntax of the example. The document contains an HTML tag (“<html>”) with two nested tags: an empty header tag (“<head>”) and a body tag (“<body>”). The body contains two paragraphs (“<p>”). Each paragraph contains text followed by an image tag (“<img>”). FIG. 2B illustrates how the XML document is represented on the WEB.

There are two markup forms that construct an XML document and that are relevant to our encoding algorithm: elements and attributes.

Elements are the most common form of markup. Elements identify the nature of the content they surround. An element begins with a start-tag and ends with an end-tag which is the same as the start-tag but has an extra slash character as a prefix. For example, the html element in FIG. 2 starts with the start-tag “<html>” and ends with the end-tag “</html>”. Element names are unique in XML.

Attributes are name-value pairs that occur inside start-tags after the element name. For example, “<img src=“sad.gif”>” is an “img” element with the attribute “src” having the value “sad.gif”. In XML, all attribute values must be quoted.

The document's DTD declares the document's meta-information: the elements names, the allowed element sequences and the elements attributes.

FIG. 3 shows the DTD of the XHTML example introduced in FIG. 2. This DTD defines a subset of the XHTML standard DTD. A HTML element “html” has a header element and body elements. The header element (“head”) has an optional “title” element. The “body” element contains multiple paragraph elements (“p”). Each paragraph contains a mixture of image elements (“img”) and text. We use this DTD herein to demonstrate the encoding principles of the present invention.

There are two relevant types of declarations in DTD: element type declaration and attribute list declaration.

An element type declaration identifies the name of a declared element (element_name) and the nature of its content (content_model) as follows: “<!ELEMENT’ element_name content_model ‘>”. The content model defines what an element may contain between the start-tag and the end-tag. The content model is defined with a regular expression. There are three types of content-models.

Element Content solely contains elements. It can contain all regular expression operators. For example, the html element declaration in FIG. 3 has the content-model “title?” The question mark after the “title” element indicates it is optional (it may be absent, or it may occur exactly once).

Mixture of Content: In addition to element names, the special symbol “# PCDATA” is reserved to indicate text. “# PCDATA” stands for “parsable character data”. Elements that contain both other elements and # PCDATA are said to have mixed content. All mixed content models must have this form: # PCDATA must come first, all of the elements must be separated by vertical bars (or relationship), and the entire group must be multiple operator (it may occur zero or more times). For example, the paragraph element declaration in FIG. 3 has the content-model “(img |# PCDATA)*”. Therefore the paragraph element contains a mixture of free text and image elements.

Empty content model indicates that the element has no content. For example, the image element content-model in FIG. 3 is empty.

An attribute list declaration identifies the element that has the attributes (element_name), its attributes (att_name), the value types of the attributes (value_type) and the default values (default_value). Its format is: “<!ATTLIST’ element_name (att_name value_type default_value)+ ’>”. For example, the attribute list declaration of the body element in FIG. 3 is:

<!ATTLIST body
fg ( black | white ) #REQUIRED
bg ( black | white ) #IMPLIED
>

The body element has two attributes, foreground (“fg”) and background (“bg”), which must be either “black” or “white”.

There are two relevant attribute value types:

A CDATA attribute has a text value.

A NMTOKEN attribute is a restricted form of the CDATA attribute. A NMTOKEN attribute may also contain multiple NMTOKEN values, separated by white space.

There are two default values for attributes.

The #REQUIRED value is explicitly specified on every occurrence of the element in the document.

The #IMPLIED value is not required, and no default value is provided.

“DTD awareness” of an XML-tool means that the tool analyzes the syntactic level of the XML document.

The basic XML-tool is the XML-parser. According to the prior art, an XML-parser is not a parser in the sense of a formal language theory. It doesn't analyze the syntactic level of the XML document. It analyzes only the lexical level and translates the XML document to a known standard form. Most XML parsers translate an arbitrary XML document to a universal tree (a DOM). DTD plays no role in prior art XML-parsers: the validity of an XML document with respect to a DTD is checked in a separate phase, for example by an XML validator. Prior art XML parsers are not DTD aware. By contrast, the XML-parser of the present invention analyzes the syntactic level of the XML document and so is a parser in the sense of formal language theory.

An XML validator validates the correctness of an XML document according to its DTD. An XML validator is fully aware of the document's DTD.

An XML converter converts data from a standard format to XML and vice versa. There exist two classes of XML converters whose output is XML code: XML to XML converters, and non-XML to XML converters. DTD awareness is needed when specifying patterns that are to be mapped to XML. Extensible Stylesheet Language Transformation (XLST) is a standard that supports XML conversion.

XML databases that store documents in a structured way are DTD-aware. The DTD is used to determine the tables in the database, and may be used to optimize queries etc. DTD awareness can be of great help when searching or querying XML documents: indexes can be built based on DTD, subtrees can be skipped when searching, etc. Current databases are not DTD aware. However, the field of XML databases is developing fast, and DTD-aware XML databases may soon emerge.

An XML editor supports editing of XML documents. Most XML editors support viewing XML documents in different ways, and they suggest elements and attributes that may be inserted at a given position. To support this features an XML editor must be a DTD-aware XML tool.

### PPM

Prediction by Partial Matching (PPM) (J. G. Cleary and I. H. Witten, “Data compressing using adaptive coding and partial string matching” IEEE Trans. Comm. Vol. 32 no. 4 pp. 396-402 (1984)) is a finite-context-model encoding. A context is a finite-length suffix of the current symbol. A context-model is a conditional probability distribution over the alphabet which is computed from the contexts. The context-model encoding uses the context-model to predict the current symbol. The prediction is encoded and sent to the decoder. The context-model is then updated by the current symbol and the encoding continues. A finite-context-model limits the length of contexts by which it predicts the current symbol. PPM denotes those finite-context-model encoding methods that use exactly one context at a time for prediction, setting aside a small probability for events unattested in the current context. When the current context does not predict the current symbol, a special “escape” event signals that fact to the decoder and compression continues with the context that is one event shorter. If zero length context does not predict the current symbol, the PPM uses an unconditional “order-1” model its baseline model.

The PPMD+ variant (W. J. Tehan and J. G. Cleary, “The entropy of English using PPM based models”, Proc. Data Compression Conference, IEEE Society Press, pp. 53-62 (1996)) we use in the present invention improves the basic PPM compression ratio in two respects: escape probability assignment and scaling.

The “D” escape probability assignment method considers the escaping events as symbols: when a symbol occurs it increments both the current symbol and the “escape” symbol counts by ½. The “D” method is generally used as the current standard method, for its generally superior performance.

The “+” term indicates the scaling technique that the algorithm employs. Scaling means distortion of probabilities measurement in order to emphasis certain characteristics of the context. Two characteristics are scaled: if the current-symbol was recently predicted in this context (recent-scaling), and if no other symbol is predicted in this context (deterministic-scaling).

The PPMD+ algorithm uses an arithmetic-coder to encode its predicted symbols.

### CFG

Over the past twenty years there have been attempts to find the best Context-Free Grammar (CFG) encoding scheme. Two compression techniques have emerged, the derivational technique and the guided-parsing technique. The core of the derivational technique (R. D. Cameron, “Source encoding using syntactic information source models”, IEEE Transactions on Information Theory vol. 34 no. 4 pp. 843-850 (1988)) is a step-by-step transmission of the derivation of a string from the goal symbol. At each step, the leftmost non-terminal is rewritten according to the grammar. Each non-terminal may only be rewritten by certain production rules. The derivational technique encodes the production rules choices.

The guided-parsing encoding method (R. G. Stone, “On the choice of grammar and parser for the compact analytical encoding of programs”, Computer Journal vol. 29 no. 4 pp. 307-314 (1986); W. S. Evans, “Compression via guided parsing”, Proc. Data Compression Conference (poster session, 1988) http://www.cs.arizona.edu/people/will/papers: guideParse.ps.gz) is based on recording the moves a parser makes while parsing the text. Stone choose LR(1) parsers for his broad coverage and thorough exploitation of grammatical information. Evans applied guided parsing to both LR(1) and LL(1) methods. Importantly, Evans pointed out that the derivational metaphor is actually the same as the guided parsing metaphor, since e.g., the derivational method replays an LL(1) parser's moves. In what follows we refer to these guided parsing techniques as LL-guided-parsing and LR-guided-parsing encoding methods.

In LL-guided-parsing the encoder sends the series of production rules that derive the encoded string. The production rules series can be extracted from the LL(1) parsing process. Each time the top of the stack contains a non-terminal a decision on the next production rule to execute the derivation is made, using a decision-table. LL-guided-parsing encodes these decisions. We demonstrate the LL-guided-parsing encoding process on the XHTML document of FIG. 2. We first introduce a grammar that defines its DTD (see FIG. 3). We leave out the attribute definitions to simplify the example. FIG. 4 defines the CFG of the XHTML subset. Only the elements are defined in this grammar. A html element (PR. 1) with a header and body elements is defined. The header element (PR.2-3) has an optional title element (PR.4). The body element (PR.5-7) contains multiple paragraph elements (PR.8-11). Each paragraph contains a mixture of image elements (PR.12) and free text.

The decision table of FIG. 4 is defined in FIG. 5. Each terminal symbol that can be a lookahead symbol defines a row. Each nonterminal symbol defines a column. When the LL-parser has a nonterminal symbol at the top of its stack, it extracts the production rule from the cell denoted by this nonterminal and the lookahead symbol.

The LL-parsing process is illustrated in FIG. 6. The parser recognizes the grammar that is defined in FIG. 4. The lookahead column details the lookahead terminal symbols. The stack column illustrates the content of the stack during the parsing. Each cell shows the stack as a set of strings delimited by commas. The gray strings are terminal symbols and the black strings are nonterminal symbols. The top of the stack symbol is the leftmost string. When the top of the stack is a nonterminal symbol (black) the parser decides which production rule to operate, using the decision table of FIG. 5. The rule column details this production rule. Note that the illustration is not complete. The second paragraph of the body element is missing. Its parsing is the same as the first paragraph. It operates production rules PR.6, PR.10, PR.9, PR.12 and PR.11.

The LL-guided-parsing compression encodes the production-rules choice which the LL-parser operates. In the parsing example of FIG. 6 the rules column content is being encoded. The naive approach is to enumerate all production rules globally and to use the global production number (GPN) (J. Tarhio, “Context coding of parse trees”, Proceedings of the Data Compression Conference (1995), p. 442) as the encoder symbols. In the above example the GPN of each production-rule is its index, as appear in the index column of FIG. 4. The encoded symbols are:

GPN: PR.1, PR.3, PR.5, PR.6, PR.10, PR.9, PR.12, PR.11, PR.7

The compression performance of GPN is not good enough. R. D. Cameron (“Source encoding using syntactic information source models”, IEEE Transactions on Information Theory vol. 34 no. 4 pp. 843-850 (July 1988)) suggested a local production rule number (LPN). LPN sequencing disposes of wider level of determinism. Each non-terminal has a limited set production that can derive it. The production rules in which it appears in the left side are enumerated. Each time this non-terminal is derived the matching LPN number is encoded. If there is a single LPN it isn't encoded at all. For example, when examining the decision-table columns in FIG. 5, we see that there are three nonterminal which have multiple production rule choice: “head”, “body_{c}” and “p_{c}”. We sort production-rules of each nonterminal by their indices and enumerate them. For example, for the ‘head’ nonterminal the local enumeration is: 1(PR.2) and 2(PR.3). This enumeration is the local production number. The local encoded symbols of the above example are:

LPN: -, 2[2], -, 1[2], -, 2[3], 1[3], -, 3[3], -

The “-” character marks a missing symbol that is encoded globally but not locally. The square brackets indicate the number of local enumerations each symbol has.

LR-guided-parsing encoding is based on information the parser has when facing a grammatical conflict. There are two kinds of conflicts that are taken into consideration:

Shift/Shift—the encoder must supply the lookahead symbol

Reduce/Reduce—the encoder indicates the production rule

The shift/reduce conflicts are not allowed in a legal LR grammar.

LR-guided-parsing exploits determinism whenever it occurs. The disadvantage of LR-guided-parsing is that top-down information is lost during encoding because of the bottom-up nature of the LR parsing process. Because of its top-down manner, LL-guided-parsing encoding exposes dependencies in the text that would otherwise remain hidden. Encoding of production rules implies that several terminals, which are part of the production rule derivation string, are encoded by one symbol. But LL-guided-parsing can also separate terminals by encoding the nonterminals in-between neighbor terminals symbols. This phenomenon is known as order-inflation. Even worse than order-inflation, it isn't even clear whether the additional nonterminals are necessary. This phenomenon is called redundant-categorization. Both phenomena, order-inflation and redundant-categorization, degrade the encoding quality. Our encoding algorithm is top-down in its nature. But it encodes terminals instead of production-rules. The encoding of terminals prevents the order-inflation and redundant-categorization phenomena occurrences.

### XML Compression

XML compression is important for two WEB application types: storage and transportation. For both, the verbose nature of XML is disturbing. The static nature of storage usually allows it to use general encoders to enhance compression. There are two variants of XML storage applications: database and archiving files. Database applications take into consideration a query mechanism which is applied on the stored XML data. Transportation applications compress the XML data as byte-codes.

The encoders differ in three criteria:
Underlying encoding algorithm: byte-codes, LZW, Huffman, arithmetic-order
Semantic awareness of structure encoding scheme: use of DTD information to enhance compression
Content encoding scheme

Transportation applications use byte-codes to transfer the encoded source. It can be either a fixed byte-code or a variable length byte byte-code. The Millau project (M. Girardot and N. Sundaresan, “Millau: an encoding format for efficient representation and exchange of XML over the Web”, Proceedings of the 9^{th} International World Wide Web Conference on Computer Networks pp. 747-765 (2000)) is the most advanced encoding for transportation applications.

Storage application use more sophisticated encoding. Xmill (H. Liefke and D. Suciu, “Xmill: an efficient compressor for XML data”, Proceedings of the ACM SIGMOD International Conference on Management of Data (2000) pp. 153-164) and XMLZip (XMLSolutions Corporation, McLean Va.) use LZW. XGRIND (P. M. Tolani and J. R. Haritsa, “XGRIND: a query-friendly XML compressor”, Database Systems Lab, SERC Indian Institute of Science, Bangalore, India, 2001) uses Huffman coding and arithmetic coding. Xmlppm (J. L. Cheney, “Compressing XML with multiplexed hierarchical models”, Proceedings of IEEE Data Compression Conference, Snowbird Utah, 2001, pp. 163-172) uses PPM encoding. Our algorithm also uses PPM.

The initial XML compression algorithms ignored the semantic level of XML. Semantic level means to use the DTD information to enhance compression performance. In the last couple of years several papers have partially addressed the issue. Xcompress (M. Levene and P. Wood, XML Structure Compression, Birkbeck College, University of London, London UK, 2002) extracts the list of expected elements from the DTD and encodes the index of the element instead of the element itself. A more sophisticated approach is used by the Millau project. It creates a tree structure for each element that is specified in the DTD. The tree includes the relation to other elements, including special operator nodes for the regular expression operators that define the element content. The XML source is also represented as a tree structure. Both trees, the DTD tree and the XML tree, are scanned in parallel and only the difference between the two representations is encoded. This method is called differential-DTD. Levene and Wood have addressed the same compression method more formally. Differential-DTD doesn't extract the whole information from DTD. The DTD attribute definition is not used by the method. Our encoding algorithm gives a general and uniform method to exploit the semantic information of the DTD.

XML-structure denotes all the tags, attributes and special characters of the XML document. XML-content donates the text (#CDATA and #PCDATA) of the XML document All existing XML compression algorithms split the structure and the content compression to different streams. Our algorithm contradicts this common approach and encodes both the structure and the content in the same stream.

In Xmlppm, XML-content is further split to attributes values (#CDATA) and text (#PCDATA). XMLZip splits its content according to a certain depth of the XML tree structure. XMill uses semantic compressors to data items with a particular structure. The semantic compressors are based on a regular-grammar parser. Our algorithm constructs a generic infrastructure that treats XML itself as grammar. It can be easily extended to other particular structures that reside in the XML-content and are defined by a regular-grammar and even a CFG.

### SUMMARY OF THE INVENTION

It is clear that a lossless compression scheme for reducing the volume of XML is needed. We present herein the best compression model for XML documents. In order to derive it we have first to understand what XML is. We treat XML herein in its most basic form—as a language. Each language has a grammar. Every grammar has a parser which recognizes it. But for XML languages this assumption is not straightforward since there is no clear definition in the prior art of what an XML-parser is. In other words, a XML-parser is actually a XML lexical-analyzer. There is no standard way in the prior art to generate XML parsers for general purposes. There is also a difficulty to determine how to transform a DTD of XML into a formal grammar definition. Our algorithm suggests how to generate automatically a XML parser according to a given DTD. This XML parser-generator can be used in a wide variety of XML applications such as validators, converters, editors, network devices (e.g., network servers), end-user devices (e.g., network clients and hand-held devices) etc.

A lossless compression scheme for XML data is needed. What is the best compression model for XML? Several papers offered solutions. None of these solutions have a full use of the syntactic information that exists in the document type declaration (DTD) to enhance XML compression. We present herein a fully syntactic based XML compression. In the present invention we treat XML in its most general form—as a language whose underline grammar is context-free. This is why we can benefit from twenty years of experience on the study of CFG source compression models and to implement a similar approach towards XML. In the present invention we exploit the common form of DTDs, to develop a new parsing technique, which is similar to LL(1) parsing. (Actually, the grammars in question are not strictly speaking context free, because the right hand side of productions are regular expressions. However, each right hand side is bracketed by a unique pair of symbols. This form facilitates top down parsing in linear time, as will is shown below). We use this notion to implement an original lossless compression technique. Our technique improves the existing CFG compression techniques for datasets that are recognized by LL(1 ) parsers.

The general approach towards XML creates a generic framework for syntactic compression. Liefke and Suciu suggested using specific syntactic compressors that are planted inside the XML compression. When XML is defined as a CFG its definition can easily be expanded to include other CFG grammars. For example, if we want to syntactically encode URL addresses inside an XML document we can expand the XML grammar with the grammar of URL. URL address definition is even more restrictive than XML (LL(1 )). It can be defined as a regular expression. The following regular expression illustrates URL-address structure:

URL::=‘http://www.’ (free-text ‘.’)? free-text ‘.’ (‘com’ | ‘org’)

The “free-text” is a predefined lexical-symbol of free text. Most of the structures that reside inside XML documents such as numbers, dates, IP addresses etc., will be processed by the XML lossless compression.

In order to compress XML we construct a parser-generator, which constitutes the core of the present invention. Our parser-generator can be used for applications other than compression. The simple and fast generation of parsers makes our parser-generation technique very practical. The XML parser-generator of the present invention can fit to wide variety of XML applications (J. Jeuring and P. Hagg, Generic Programming for XML Tools, Institute of Information and Computing Sciences, Utrecht University, The Netherlands, May 2002) such as validators, converters, editors, network devices (e.g., network servers), end-user devices (e.g., network clients and hand-held devices) etc.

The flow of the algorithm of the present invention is given in FIG. 1. It contains four sub-modules:

Syntactic dictionary conversion (specifically, DTD conversion) 10: converts a DTD 5 to a D-grammar.

XML parser-generator 20: creates a parse table 25 for a generic XML parser 30 from DTD 5.

XML parser 30: uses parse table 25 to parse the XML document 35.

PPM encoder 40: encodes the moves of parser 30.

Each element in a syntactic dictionary generally, and in DTD 5 structure can be rephrased as a regular expression. This simple translation precedes the parser generator. We call the translated DTD a DTD-grammar 15 (D-grammar) that describes the XML language. We construct a Deterministic Pushdown Transducer (DPDT) that acts as a parser for the given D-grammar 15. The DPDT is an XML parser 30 for XML documents 35 of the given DTD 5. The third phase of the encoding algorithm uses PPM, which is considered to be the state of the art for text encoding. Encoder 40 uses the parsing process to decide which lexical symbols are relevant to the current elements' state. Only these symbols participate in the encoding process.

The decoder decodes the lexical symbols and sends the decoded symbols to XML parser 30. Parser 30 transforms the decoded symbols to their original XML form and writes them to a file.

Therefore, according to the present invention there is provided a method of generating a parser of a source code file that references a syntactic dictionary for the source code, including the steps of: (a) converting the syntactic dictionary into a corresponding plurality of expressions of a context-free grammar, the expressions being a grammar of the source code of the file; and (b) constructing the parser from the expressions.

Furthermore, according to the present invention there is provided a computer readable storage medium having computer readable code embodied on the computer readable storage medium, the computer readable code for generating a parser of a source code file that references a syntactic dictionary for the source code, the computer readable code including: (a) program code for converting the syntactic dictionary into a corresponding plurality of expressions of a context-free grammar, the expressions being a grammar of the source code of the file; and (b) program code for constructing the parser from the expressions.

Furthermore, according to the present invention there is provided a method of compressing a file that includes source code and that references a syntactic dictionary for the source code, the syntactic dictionary including at least one attribute definition, the method including the steps of: (a) converting the syntactic dictionary into a corresponding plurality of expressions of a context-free grammar, the expressions being a grammar of the source code of the file; (b) constructing a parser of the source code from the expressions; and (c) compressing the source code using the parser.

Furthermore, according to the present invention there is provided a method of transmitting, from a transmitter to a receiver, a file that includes source code and that references a syntactic dictionary for the source code, the method including the steps of: (a) at the transmitter and at the receiver: (i) converting the syntactic dictionary into a corresponding plurality of expressions of a context-free grammar, the expressions being a grammar of the source code of the file, and (ii) constructing a parser of the source code from the expressions; (b) at the transmitter, processing the source code using the parser that is constructed at the transmitter; and (c) at the receiver, recovering the source code from output of the processing, using the parser that is constructed at the receiver.

Furthermore, according to the present invention there is provided a method of compressing a file that includes source code and that references a syntactic dictionary for the source code, the source code including both structure and contents, the method including the steps of: (a) converting the syntactic dictionary into a corresponding plurality of expressions of a context-free grammar, the expressions being a grammar of the source code of the file; (b) constructing a parser of the source code from the expressions; and (c) compressing the source code using the parser; wherein the compressing of the source code encodes both the structure and the content in a single common stream.

Furthermore, according to the present invention there is provided a computer readable storage medium having computer readable code embodied on the computer readable storage medium, the computer readable code for compressing a file that includes source code and that references a syntactic dictionary for the source code, the computer readable code including: (a) program code for converting the syntactic dictionary into a corresponding plurality of expressions of a context-free grammar, the expressions being a grammar of the source code of the file; (b) program code for constructing a parser of the source code from the regular expressions; and (c) program code for compressing the source code using the parser.

Furthermore, according to the present invention there is provided a computer readable storage medium having computer readable code embodied on the computer readable storage medium, the computer readable code for compressing a file that includes source code and that references a syntactic dictionary for the source code, the source code including both structure and contents, the computer readable code including: (a) program code for converting the syntactic dictionary into a corresponding plurality of expressions of a context-free grammar, the expressions being a grammar of the source code of the file; (b) program code for constructing a parser of the source code from the expressions; and (c) program code for compressing the source code using the parser; wherein the compressing of the source code encodes both the structure and the content in a single common stream.

Furthermore, according to the present invention there is provided an apparatus for parsing a source code file that references a syntactic dictionary for the source code, including: (a) a dictionary converter for converting the syntactic dictionary into a corresponding plurality of expressions of a context-free grammar, the expressions being a grammar of the source code of the file; (b) a parser generator for creating at least one parse table for the source code from the expressions; and (c) a parser for parsing the source code according to the at least one parse table.

Furthermore, according to the present invention there is provided a method of generating a parser of an XML file that includes XML code and that references a syntactic dictionary for the XML code, including the steps of: (a) converting the syntactic dictionary into a corresponding plurality of expressions of a context-free grammar, the expressions being a grammar of the XML code of the file; and (b) constructing the parser from the expressions.

Furthermore, according to the present invention there is provided a computer readable storage medium having computer readable code embodied on the computer readable storage medium, the computer readable code for generating a parser of a XML file, the XML file including XML code and referencing a syntactic dictionary for the XML code, the computer readable storage medium including: (a) program code for converting the syntactic dictionary into a corresponding plurality of expressions of a context-free grammar, the expressions being a grammar of the XML code of the file; and (b) program code for constructing the parser from the expressions.

Furthermore, according to the present invention there is provided a method of compressing a XML file that includes XML code and that references a syntactic dictionary for the XML code, the syntactic dictionary including at least one attribute definition, the method including the steps of: (a) converting the syntactic dictionary into a corresponding plurality of expressions of a context-free grammar, the expressions being a grammar of the XML code of the file; (b) constructing a parser of the XML code from the regular expressions; and (c) compressing the XML code using the parser.

Furthermore, according to the present invention there is provided a method of transmitting, from a transmitter to a receiver, a XML file that includes XML code and that references a syntactic dictionary for the XML code, the method including the steps of: (a) at the transmitter and at the receiver: (i) converting the syntactic dictionary into a corresponding plurality of expressions of a context-free grammar, the expressions being a grammar of the source code of the file, and (ii) constructing a parser of the XML code from the expressions; (b) at the transmitter, processing the source code using the parser that is constructed at the transmitter; and (c) at the receiver, recovering the source code from output of the processing, using the parser that is constructed at the receiver.

Furthermore, according to the present invention there is provided a method of compressing a XML file that includes XML code and that references a syntactic dictionary for the XML code, the XML code including both structure and contents, the method including the steps of: (a) converting the syntactic dictionary into a corresponding plurality of expressions of a context-free grammar, the expressions being a grammar of the XML code of the file; (b) constructing a parser of the XML code from the expressions; and (c) compressing the XML code using the parser; wherein the compressing of the XML code encodes both the structure and the content in a single common stream.

Furthermore, according to the present invention there is provided a computer readable storage medium having computer readable code embodied on the computer readable storage medium, the computer readable code for compressing a XML file, the XML file including XML code and referencing a syntactic dictionary for the XML code, the computer readable code including: (a) program code for converting the syntactic dictionary into a corresponding plurality of expressions of a context-free grammar, the expressions being a grammar of the XML code of the file; (b) program code for constructing a parser of the XML code from the expressions; and (c) program code for compressing the XML code using the parser.

Furthermore, according to the present invention there is provided a computer readable storage medium having computer readable code embodied on the computer readable storage medium, the computer readable code for compressing a XML file, the XML file including XML code and referencing a syntactic dictionary for the XML code, the XML code including both structure and contents, the computer readable code including: (a) program code for converting the syntactic dictionary into a corresponding plurality of expressions of a context-free grammar, the expressions being a grammar of the XML code of the file; (b) program code for constructing a parser of the XML code from the expressions; and (c) program code for compressing the XML code using the parser; wherein the compressing of the source code encodes both the structure and the content in a single common stream.

Furthermore, according to the present invention there is provided an apparatus for parsing an XML file that includes XML code and that references a syntactic dictionary for the XML code, including: (a) a dictionary converter for converting the syntactic dictionary into a corresponding plurality of expressions of a context-free grammar, the expressions being a grammar of the XML code of the file; (b) a parser generator for creating at least one parse table for the XML code from the expressions; and (c) a parser for parsing the XML code according to the at least one parse table.

The present invention is of methods for generating a parser of, compressing, and transmitting source code that references a syntactic dictionary. A “syntactic dictionary” is herein understood to be a declaration of the syntax of a file of source code. For example, the DTD or the schema of a XML file is the syntactic dictionary of the XML file. Other languages, such as HTML, have similar syntactic dictionaries. The scope of the present invention includes all such languages, although the examples presented herein are confined to XML. The syntactic dictionary of a source code file may be included in the file itself or may be in a separate file that is referenced by the source code file. Both ways of connecting a syntactic dictionary to source code are considered herein to be “referencing” the syntactic dictionary by the source code. In the examples of XML files used herein, the syntactic dictionaries are DTDs that are included in the files.

A parser of a source code file is generated by converting the source code's syntactic dictionary into a corresponding plurality of expressions of a context-free grammar and then constructing the parser from those expressions. In the present context, “constructing” a parser means creating source-code-specific parse tables that are input to a generic parser.

The structure of a formal language such as a programming language, or the structure of a specific XML document, may be described by a formal grammar. Traditionally, programming languages have been described by Backus-Naur-Form (BNF), which is a form of a context-free grammar. Extended BNF (EBNF) adds several syntactic forms that make the description more concise.

D-grammars are another variant of context-free grammars. D-grammars allow the use of regular expressions, which are not part of the EBNF notation. It is possible to convert a D-grammar to EBNF, but then the parsing process exhibits a finer, more detailed structure than is needed. Specifically, instead of one step in the derivation from an element to the sequence of elements at the next level, parsing EBNF expressions would exhibit a sequence of steps that are not relevant to the desired structure.

Therefore, preferably, the context-free grammar of the present invention preferably is a D-grammar and the expressions preferably are regular expressions. Alternatively but less preferably, the context-free grammar is a BNF or an EBNF, in which case the parsing process generates and discards the intermediate steps mentioned above. Under this alternative, it is preferred that the BNF or EBNF be equivalent to a D-grammar.

Preferably, the parser is a deterministic pushdown transducer.

A file of source code, whose syntactic dictionary includes at least one attribute definition, is compressed by generating a corresponding parser of the present invention and then compressing the source code using that parser. Preferably, the compression of the source code is based at least in part on the attribute definition(s) of the syntactic dictionary.

Preferably, the compression of the source code includes tokenizing the source code to produce a plurality of tokens that are input to the parser. Most preferably the parser produces a left parse of each token. Also most preferably, the compression of the source code includes local encoding of each token as guided by the parser.

A file of source code, whose syntactic dictionary includes at least one attribute definition, is transmitted from a transmitter to a receiver by generating a corresponding parser of the present invention at the transmitter and processing (e.g., compressing) the source code at the transmitter using that parser. At the receiver, the same parser is used to recover the source code from the output of the processing at the transmitter. For example, if the transmitter compressed the source code, then the receiver decompresses the received compressed code. To make sure that the transmitter and the receiver use the same parser, the transmitter and the receiver are provided with the same syntactic dictionary, for example by negotiating the syntactic dictionary in advance or by transmitting the syntactic dictionary separately from the transmitter to the receiver.

A file of source code, that includes both structure and content, and whose syntactic dictionary includes at least one attribute definition, is compressed by generating a corresponding parser of the present invention and then compressing the source code using that parser. The compressing of the source code encodes both the structure of the source code and the content of the source code in a single common stream.

An important special case of the present invention is that in which the source code is XML code. In that case, the syntactic dictionary usually is the document type declaration of the XML source code or the XML schema of the XML source code.

The scope of the present invention also includes computer readable storage media that have embodied thereon program code for implementing the methods of the present invention: program code for generating a parser of a file of source code that references a syntactic dictionary; program code for compressing such a file; program code for decompressing the resulting compressed source code; and/or program code for compressing a file of source code, that includes both structure and contents and that references a syntactic dictionary, that encodes both the structure and the contents in a single common stream.

The scope of the present invention also includes an apparatus for parsing a source code file that references a syntactic dictionary. The apparatus includes a dictionary converter for converting the syntactic dictionary into a corresponding plurality of expressions, of a context-free grammar, that are a grammar of the source code. The apparatus further includes a parser generator for creating one or more parse tables for the source code from the expressions of the context-free grammar, and also a parser for parsing the source code according to the parse table(s).

One application of the apparatus is as part of a source code compressor. Preferably, the apparatus used in the source code compressor also includes a lexical analyzer for tokenizing the expressions of the context-free grammar, thereby producing a plurality of syntactic dictionary tokens, and for transforming each of the syntactic dictionary tokens to a corresponding lexical symbol. The parser generator creates the parse table(s) from the lexical symbols.

Most preferably, the apparatus used in the source code compressor also includes a source language tokenizer for tokenizing the source code in accordance with the lexical symbols, thereby producing a plurality of source code tokens that are parsed by the parser. Also most preferably, the apparatus used by the source code compressor also includes an encoder for encoding the output of the parser.

Other applications of the apparatus are as part of a source code decompressor, as part of a source code validator, as part of a source code converter, as part of a source code editor, as part of a network device such as a network router, a network switch, a network security gateway or a network manager, or as part of an end-user device. (A network device is distinguished from an end-user device by being at an intermediate node of a network.) Examples of such end-user devices include personal computers and hand-held devices such as personal data assistants, cellular telephones and smart cards. One significant use of a network device that includes the apparatus is for monitoring quality of service.

### BRIEF DESCRIPTION OF THE DRAWINGS

The invention is herein described, by way of example only, with reference to the accompanying drawings, wherein:

FIG. 1 shows the main submodules of the XML compression algorithm of the present invention;

FIG. 2A is the XHTML document that is used as an example herein;

FIG. 2B shows how the document of FIG. 2A is represented on the WEB.

FIG. 3 is the DTD of the document of FIGS. 2A and 2B;

FIG. 4 is a CFG definition of the XHTML subset declared in FIG. 3;

FIG. 5 is a decision table of the CFG defined in FIG. 4;

FIG. 6 illustrates the parsing process of the XTHML document of FIGS. 2A and 2B;

FIG. 7 is a flow chart of the XML compression algorithm of the present invention;

FIG. 8A is a DTD description of the XTHML subset;

FIG. 8B is a Regular Expression description of the XTHML subset;

FIG. 9 is a finite state machine for the RegExp-lexer of FIG. 7;

FIG. 10 shows the Finite State Automata that accept the XTHML elements of FIGS. 8A and 8B;

FIG. 11 shows the DPDT parsing of the XTHML document of FIGS. 2A and 2B;

FIG. 12 shows a XML tokenizer state machine;

FIG. 13 is a table of XHTML relevant symbols that are constructed from the transitions of FIG. 10;

FIGS. 14A and 14B show a DPDT-guided encoding of an attribute's value content of an img element;

FIG. 15 is a partial high-level block diagram of a system for implementing the present invention;

FIG. 16 is a partial high-level block diagram of a PCI card for implementing the present invention;

FIG. 17 is a flow chart of an XSLT converter of the present invention.

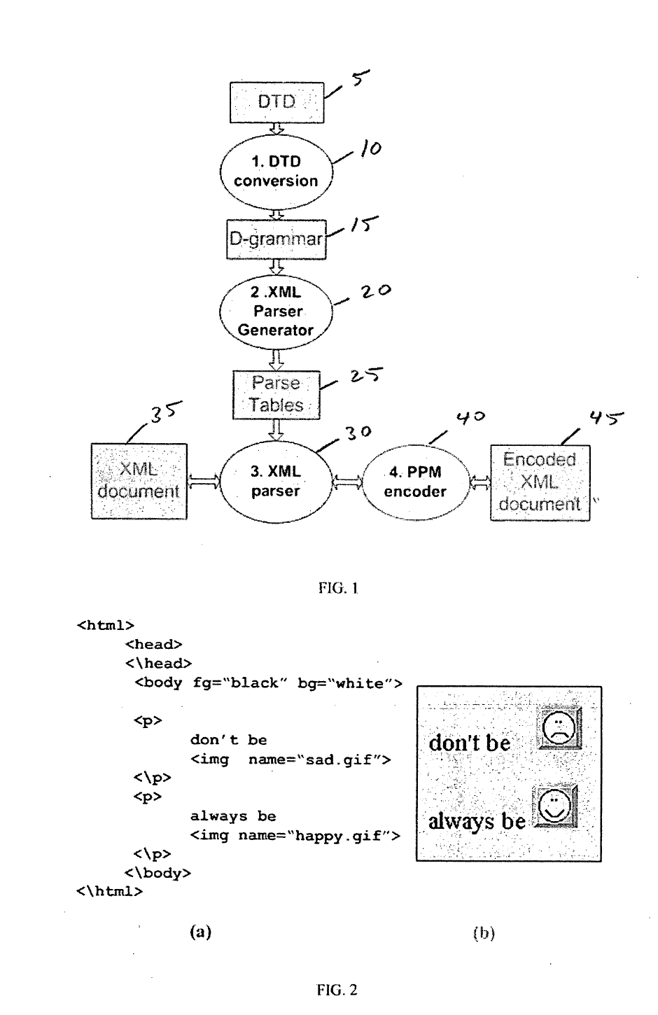

### DESCRIPTION OF THE PREFERRED EMBODIMENTS

The present invention is of a parser-generator, and of the use of the parser so generated for parsing and compressing source code with reference to a syntactic dictionary of that source code. Specifically, the present invention can be used to parse and compress XML code.

The principles and operation of a parser-generator and of source code compression according to the present invention may be better understood with reference to the drawings and the accompanying description.

### The XML Compression Algorithm

The XML compression algorithm has two sequential components:

1. Generation of an XML parser from the DTD of the XML code

2. XML compression using the parser from the first component.

In the first component, the DTD description is converted into a set of regular expressions (RE). Each XML-element is described as a single RE. Then, an XML parser is generated from this description in the following way. A Deterministic Pushdown Transducer, that produces a leftmost parse, is generated; this is similar to a LL parser. The output of the parser—namely the leftmost parse—is used as input to the guided parsing compression, which constitutes the second component of the algorithm.

The guided parsing and compression has three components:

1. The XML tokenizer accepts the XML source code and outputs lexical tokens.

2. The parser parses the lexical tokens.

3. The PPM encoder encodes the lexical symbols using information from the parser.

The first two components effect the guided parsing. The third component effects the compression. PPM is only an example of a suitable compression method. Those skilled in the art will readily envision other suitable methods, such as Lempel Ziv Welch (LZW) compression and WINZIP compression.

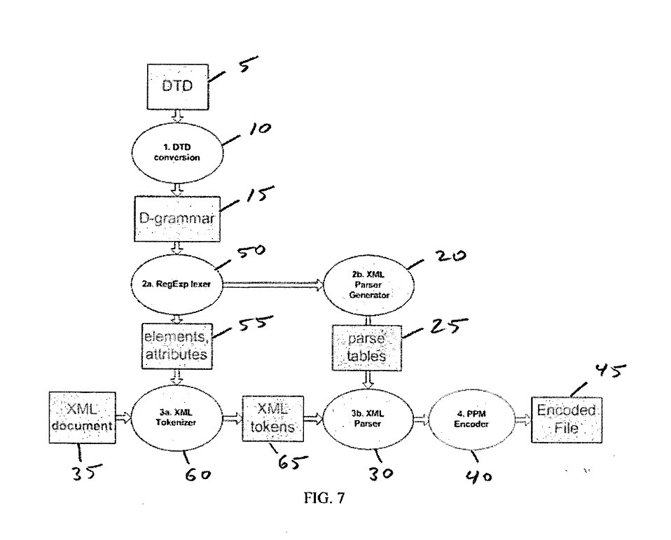

Referring again to the drawings, the flow of the algorithm is described in FIG. 7. The vertical flow describes sequential stages. The horizontal flow describes the iterative parsing and the encoding process. Two parsers, XML parser 30 and parser generator 20, operate independently. They contain the same iterative process.

We describe now the flow of DTD conversion in FIG. 7. DTD 5 is translated into a set of REs. An XML element is described as a concatenation of a start tag string, attributes list, the element's content and the end tag string. The RE syntax is given as:

“<element” attributes “>” content “</element>”.

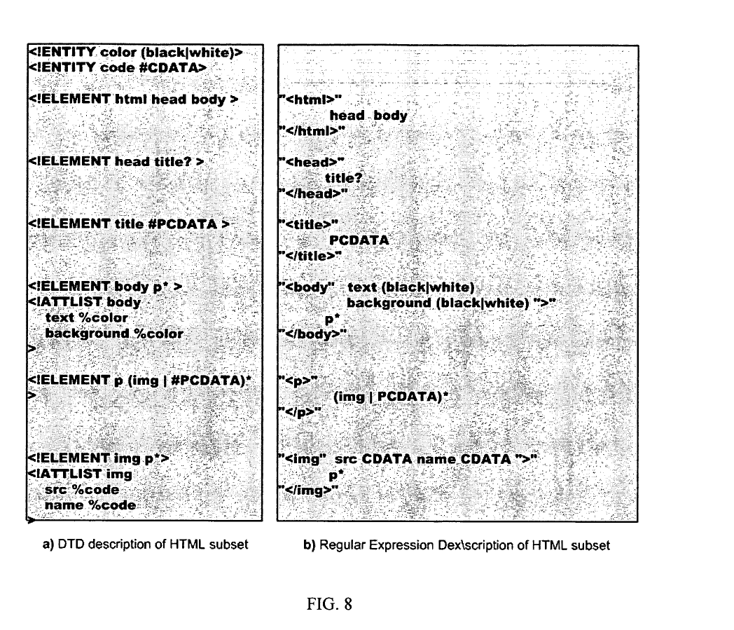

FIG. 8 demonstrates how a XHTML subset is converted from its original DTD 5 (FIG. 8A) into a RE description. The attributes are described as a concatenation of the pair attribute and value. Implied attributes are described with the optional operator character ‘?’. Text-free attribute-values are described with the reserved string CDATA. A selection of attribute-values is described as in DTD 5. FIG. 8B demonstrates all the attributes conversion to RE:

The “src” attribute of the “img” element is an explicit attribute with free text value. Its RE conversion is “src CDATA”.

The “name” attribute of “img” element is an implicit attribute with free-text value. Its RE conversion is ‘?(name CDATA)’.

The “text” attribute of the “body” element is an explicit attribute with selection of values “black” or “white”. Its RE conversion is “text (black-white)”.

The reserved PCDATA string is used for free text elements. See for example the title element content.

We describe now the flow of the Regular Expression lexical analyzer (RegExp lexer) 50 in FIG. 7. The RE has two types of tokens:
Operator characters: (,), |, space, *, +, ?
Textual tokens

RegExp lexer 50 has three functions:
Tokenizes a regular expression.
Generates a lexical symbol from tokens.
Classifies textual token by its XML-entity types which are element, attribute and attribute's value.

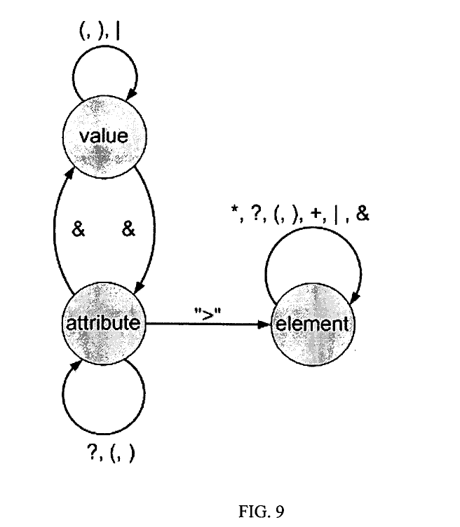

A state machine with three states is used to tokenize the RegExp (see FIG. 9). Each state fits a different XML-entity type. Each token is replaced with a lexical symbol. The lexical symbol is given to XML parser generator 20 as an input symbol. It is saved in RegExp-lexer 50 for a future use by the next analyzed tokens and by XML tokenizer 60. XML-tokenizer 60 inherits its lexical symbols' table 55 from RegExp-lexer 50. The XML entity type, which is known according to the current lexer state, is also saved. The XML-entity type will be used by XML-tokenizer 60 in order to correctly represent a decoded token.

Next we discuss the parsing algorithm used to parse an XML file 35. Note that we use the term parsing as is common in Computer Science (e.g. Formal Language Theory, Compilers, etc.). This is in contrast to the use of the term parsing in some of the XML literature, as noted in the Background section.

We rely on the fact that the DTD part of XML file 35 constitutes an Extended Backus Normal Form (EBNF) grammar for the rest of file 35. EBNF grammars are not strictly Context Free grammars (CFGs), because they use some form of regular expressions in the right hand side of productions. On the other hand, each XML element is delimited by a unique pair of start tag and end tag (in angled brackets). This fact is used to simplify the parsing process.

For example, “<html>” is the right bracket of the first Regular Expression in FIG. 8, and “</html>” is the left bracket. None of them appear elsewhere in the grammar.

In our presentation, we will consider the special form of a DTD grammar, which we call D-grammar. We assume the reader is familiar with the basics of Automata, Language and Parsing Theory. We base our presentation on notation from A. V. Aho and J. D. Ullman, The Theory of Parsing, Translation and Compiling, Vol. I, Prentice-Hall, 1972.

Definition 1. A D-grammar is a 4-tuple G=(N,Σ,P,A₁) where N={A₁,A₂ , . . . ,Aₙ} is a finite non-empty set of non terminals, Σ is a finite non-empty set of terminal symbols, divided between two disjoint subsets Σ={a₁,\overline{a}₁,a₂,\overline{a}₂, . . . ,aₙ,\overline{a}ₙ}∪Σ′. A₁ is the start symbol, and P is a non empty set of bracketed productions, with the following form: each non terminal Aᵢ has a unique production Aᵢ→aᵢRᵢ\overline{a}ᵢ, where aᵢ,\overline{a}ᵢ∈Σ are the left and right bracket for Aᵢ, respectively, and Rᵢ is a regular expression over N∪Σ′ (we will call it Aᵢ's regular expression). Note that the brackets of different non terminals are distinct.

For example, in the grammar of FIG. 8, N={html,head,title,body,p,img}, A₆=img, a₆=‘<img’, \overline{a}₆=‘</img>’, and R₆=src CDATA name CDATA>p*.

A D-grammar is used to derive words in Σ* by repeatedly applying production to a non terminal symbol. This is similar to the way a CFG is used, except that the right hand side of a production is not a fixed word, like in a CFG, so when a production of Aᵢ→aᵢRᵢ\overline{a}ᵢ of a D-grammar is applied to Aᵢ, Aᵢ, is replaced by an arbitrary word aᵢβ\overline{a}ᵢ, such that β∈Rᵢ.

More formally, we define:

Definition 2. Let G=(N,Σ,P,A₁) be a D-grammar. We define the relation [symbol] (read “derives”) on words over N∪Σ as follows. If A∈N, α, γ∈(N∪Σ)*, A→aR\overline{a}∈P and β∈Rᵢ, then αAγ [symbol] αβγ. We will also say that αAγ [symbol] αβγ uses the production A→aR\overline{a}∈P. If α∈Σ*, then we call the derivation leftmost, and denote it by αAγ [symbol] _{L}αβγ. (Henceforth we will be interested only in leftmost derivations). We use the usual notation for the reflexive transitive closure of the derives relation to indicate derivation of any length: If δ₀ [symbol] _{L}δ₁ [symbol] _{L} . . . [symbol] _{L}δₘ for some m≧0, then we write δ₀ [symbol] _{L}*δₘ.

Further, if for each j,0≦j≦m−1, δⱼ [symbol] _{L} δⱼ₊₁ uses production Aᵢ_{ⱼ}→aᵢ_{ⱼ}Rᵢ_{ⱼ}\overline{a}ᵢ_{ⱼ}∈P, then the leftmost parse of the derivation δ₀ [symbol] _{L}*δₘ is the sequence of production numbers i₀i₁ . . . iₘ₋₁ which we will denote π(δ₀ [symbol] _{L}*δₘ).

The language defined by a non terminal symbol Aᵢ, is L(Aᵢ)={w∈Σ*|Aᵢ [symbol] _{L}*w)}. The language defined by the grammar is simply the language defined by the start symbol A₁.

We will now show how to construct a Deterministic Pushdown Transducer (DPDT) that acts as a parser for the given D-grammar. A DPDT is a pushdown automaton with output. First we present a definition of a DPDT adapted from Aho and Ullman, but simplified: For our purpose, we need not be concerned with ε moves.

Definition 3. A (ε free) Deterministic Pushdown Transducer, (henceforth simply DPDT) is a 8-tuple M=(Q,Σ,Γ,Δ,δ,q₀,Z₀,F) where Q is a finite set of states, Σ is a finite input alphabet, Γ is a finite pushdown alphabet, Δ is a finite output alphabet, δ is a function from Q×Σ×Γ to Q×Γ*×Δ* called the transition function, q₀∈Q is the initial state, Z₀ is the initial stack symbol, and F⊂Q is the set of final or accepting states.

A configuration of M is a 4-tuple (q,w,γ,v) in Q×Σ*×Γ*×Δ*, where q is the current state of M, w is the unread portion of the input, γ is the content of the stack, (its leftmost symbol is the top of the stack), and v is the output produced so far.

A move of M is represented by a relation [symbol] between configurations, defined as follows: (q,aw,Zα,v) [symbol] (p,w,γα,vu) if δ(q,a,Z)=(p,γ,u), for some q,p∈Q,a∈Σ,w∈Σ*,Z∈Γ,γ,α∈Γ* and v,u∈Δ*.

We use [symbol] * to denote a computation of any length.

A word w is accepted by M and translated into v if (q₀,w,Z₀,ε) [symbol] *(q,ε,ε,v) for some p∈F: when M is started in its initial state, with the stack containing the initial symbol, and with w in its input, it terminates in a final state, with an empty stack, having consumed all its input, and produced v as its output.

We will now present the DPDT M that is constructed to act as a parser for a given D-grammar. Given a word w∈Σ*, if w is generated by the D-grammar, then given w$ as input, (where $ is a special end marker), M will read the input to completion, terminate in an accepting state and empty the stack, and produce as output the leftmost parse π(A₁ [symbol] _{L}*w). Otherwise the DPDT will reject w$—it will not terminate as described.

The construction of M is defined as follows.

Definition 4. Let G=(N,Σ,P,A₁) be a D-grammar, and let M₀,M₁,M₂, . . . ,Mₙ be Finite State Automata (FSA), so that for i≧1, Mᵢ accepts the language Rᵢ, Aᵢ's regular expression. The FSA M₀ is added to simplify the construction. It accepts the language {A₁}.

In particular, Mᵢ=(Qᵢ,N∪Σ′,δᵢ,q₀ᵢ,Fᵢ). For M₀, specifically, Q₀={q₀₀,f₀}, F₀={f₀}, δ₀(q₀₀, A₁)=f₀ and δ₀ is undefined elsewhere. We assume, without loss of generality, that the sets of states Qᵢ are disjoint.

We now define a DPDT as follows: M=(Q,Σ∪{$},Γ,Δ,δ,q₀₀,Z₀,{f₀}) where

$$Q = {{⋃}_{i = 0}}^{n} {Q}_{i} , Γ = \{ {Z}_{0} \} ⋃ \{ [ q , {a}_{i} ] \vert q ∈ Q , 0 \leq i \leq n \} .$$

The output alphabet Δ={1,2, . . . ,n} represents production numbers. The transition function δ has four types of rules, depending on the type of input symbol:

Type 1: For all 1≦i≦n,0≦j≦n,Z∈Γ and q∈Qⱼ, we have δ(q,aᵢ,Z)=(q₀ᵢ,[δⱼ(q,Aᵢ),aᵢ]Z,i) (left bracket).

Type 2: For all 1≦i≦n,q∈Q, and p∈Fᵢ, we have δ(p,\overline{a}ᵢ,[q,aᵢ])=(q,ε,ε) (right bracket).

Type 3: For all 0≦i≦n,q∈Qᵢ,a∈Σ′ and Z∈Γ, we have δ(q,a,Z)=(δᵢ(q,a),Z,ε) (non bracket symbol).

Type 4: δ(f₀,$,Z₀)=(f₀,ε,ε) (end marker).

δ is undefined for all other values of its arguments.

In what follows, we will use [symbol] ⁱ (and [symbol] ⁱ*) to denote a computation step (sequence of steps) of type i.

It can easily be seen that M is deterministic, and has no ε moves.

M operates as follows. When given non bracket symbols, M simulates the behavior of an individual FSM in its state, each time following a word β to see if it belongs to a specific Rⱼ (type 3 moves). Whenever a left bracket aᵢ appears in the input, the DPDT must suspend its simulation of the current FSM Mⱼ, pushing onto the stack a symbol that combines the state q∈Qⱼ from which this simulation is to be resumed later (explained below), and the left bracket aᵢ. M then starts a simulation of the regular expression Rᵢ by changing it's state to the initial state q₀ᵢ of the corresponding FSM Mᵢ (type 1 move). Whenever a right bracket \overline{a}ᵢ is read, M must be in an accepting state p∈Fᵢ of the current FSM being simulated Mᵢ. Further, the right bracket being read \overline{a}ᵢ must match the left bracket aᵢ on the stack. If these conditions hold, then the stack symbol [q,aᵢ] is popped and the simulation resumes from the state q∈Qⱼ (type 2 move).

The state q∈Qⱼ from which simulation is to be resumed (which is pushed onto the stack along with the right bracket) is computed as follows. The right bracket aᵢ that causes suspension uniquely determines the non terminal symbol Aᵢ for which a derivation step is considered. When the simulation of Mᵢ is completed in an accepting state, and followed by the appearance of \overline{a}ᵢ in the input, this corresponds to completion of the right hand side of the production Aᵢ→aᵢRᵢ\overline{a}ᵢ. As far as the FSM Mⱼ, whose operation have been suspended, this amounts to viewing the symbol Aᵢ, so the state in which the simulation should be resumed should be δⱼ(q,Aᵢ), where q was the state in which the simulation of Mⱼ was suspended. (This justifies the definition of a type 1 move).

One can see that the DPDT traverses the derivation tree left to right, top down. It moves down when processing left brackets (type 1), right when processing non bracket symbols (type 3), and up when processing right brackets (type 2). It pushes a symbol on the stack while going down, and pops a symbol while going up. It produces an output symbol only when it goes down—it outputs the production number i when reading aᵢ. After reading a word w∈A₁, M will be in its accepting state, and the stack will contain the initial stack symbol only. Reading the end marker will now empty the stack (type 4), terminating the computation successfully. One can see that if the computation terminates successfully, the resulting output is exactly the left parse of the input word.

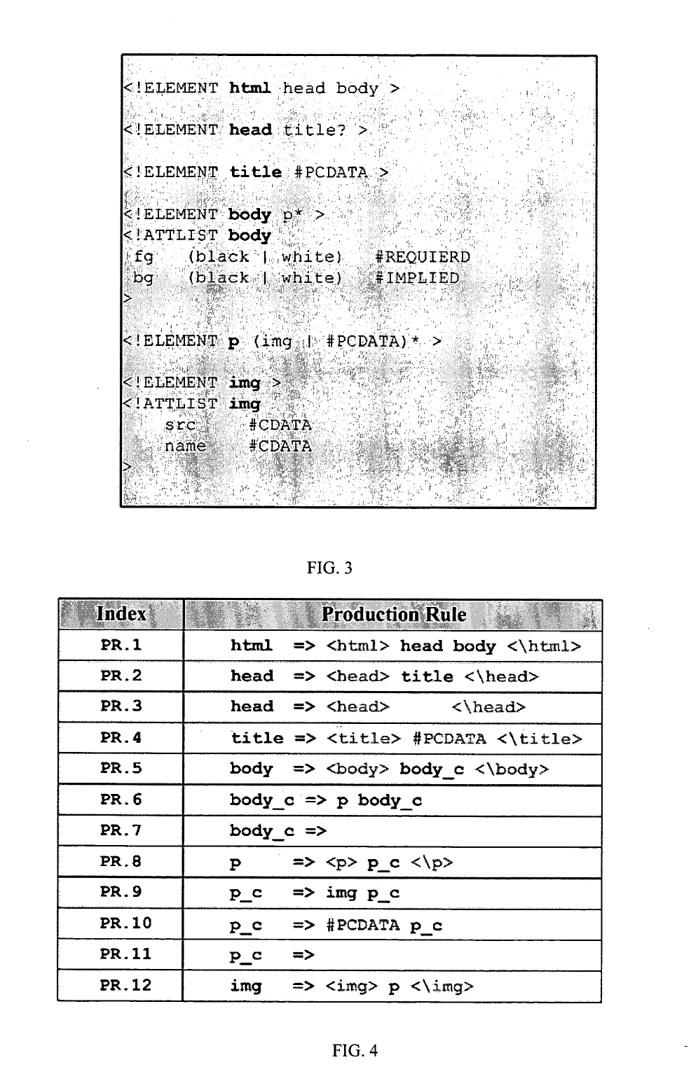

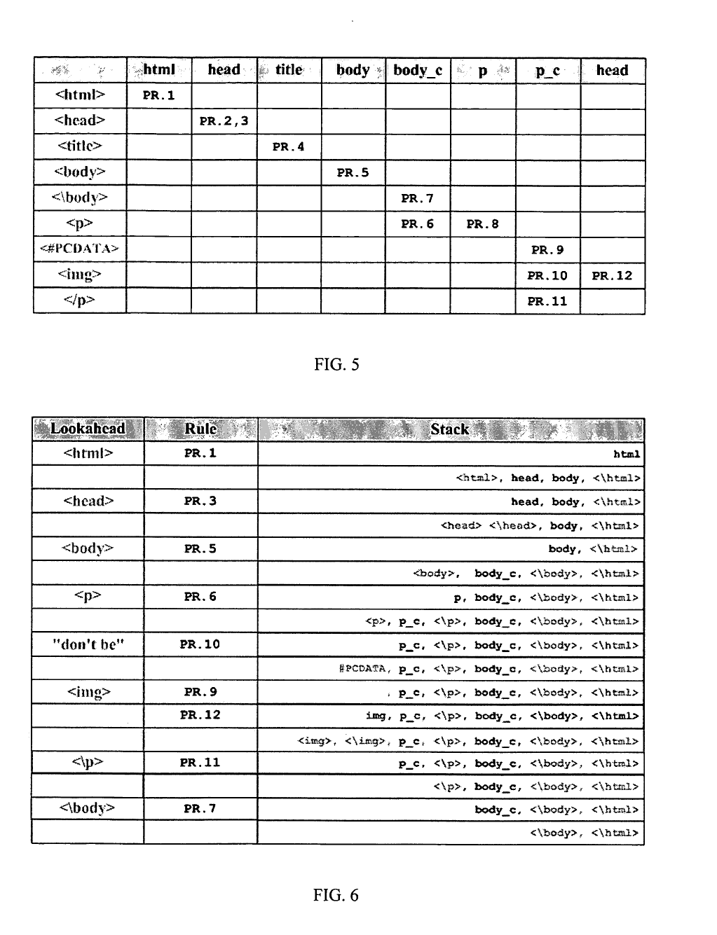

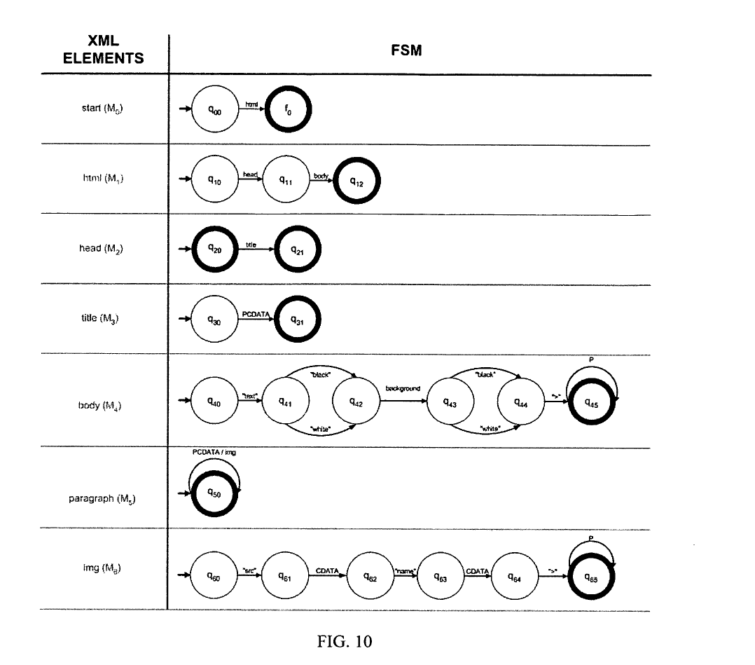

We demonstrate the DPDT operation on the XHTML of FIG. 2. FIG. 10 illustrates the FSA (Mᵢ) constructed from the DTD of FIG. 3. There are seven FSAs, one for each of the six nonterminals (M₁-M₆) and M₀ which is used to start the transcoding. The circles are states of the FSA. Accepting states are denoted by a thick circle. Start states are denoted by an incoming arrow.

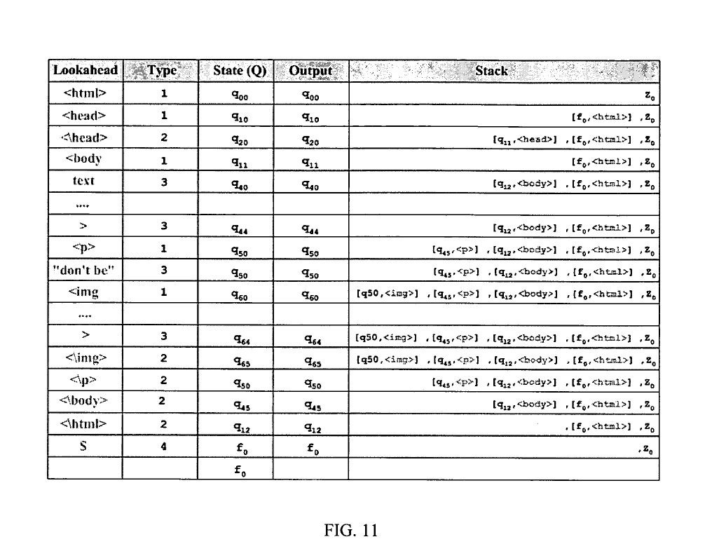

FIG. 11 details the DPDT operation. The table contains four columns: the lookahead lexical symbol, the transition type (1-4), the current transcoder state and the current stack content.

The proof that the DPDT indeed works as expected, will proceed by proving a series of lemmas:

The first lemma shows how to partition a derivation tree into its top production and a collection of subtrees.

Lemma 1. Let w be a word in aᵢΣ*\overline{a}ᵢ for some i,1≦i≦n. Then w∈L(Aᵢ) if and only if w can be partitioned as w=aᵢx₁y₁x₂y₂ . . . xₖyₖxₖ₊₁\overline{a}ᵢ for some k≧0, such that
for all 1≦j≦k+1,xⱼ∈Σ′*
For all 1≦j≦k,yⱼ∈L(Aᵢ_{ⱼ}) for some Aᵢ_{ⱼ}∈N, and
ŵ=x₁Aᵢ_{₁}x₂Aᵢ_{₂} . . . xₖAᵢ_{ₖ}xₖ₊₁∈Rᵢ,
   Furthermore, ŵ is uniquely determined from w.

Proof. If w∈L(Aᵢ), then there must be a derivation Aᵢ [symbol] _{L}aᵢŵ\overline{a}ᵢ [symbol] _{L}*w, such that ŵ∈Rᵢ. Furthermore, since ŵ, has no bracket symbols (by the definition of the regular expressions in a D-grammar), there is a unique way to decompose around its k≧0 nonterminal symbols, ŵ=x₁Aᵢ_{₁}x₂Aᵢ_{₂} . . . xₖAᵢ_{ₖ}xₖ₊1, where xⱼ∈Σ′* for 1≦j≦k+1, and Aᵢ_{ⱼ}∈N for 1≦j≦k. So the derivation aᵢŵ\overline{a}ᵢ [symbol] _{L}*w can be rewritten as
aᵢx₁Aᵢ_{₁}x₂Aᵢ_{₂} . . . xₖAᵢ_{ₖ}xₖ₊₁\overline{a}ᵢ [symbol] _{L}* aᵢx₁y₁x₂y₂ . . . xₖyₖxₖ₊₁\overline{a}ᵢ
where for each j,1≦j≦k+1, Aᵢ_{ⱼ} [symbol] _{L}*yⱼ. The other direction is trivial. Q.E.D.

Next, we show how the DPDT simulates a single FSA on a string of non brackets that belongs to some L(Aᵢ).

Lemma 2. For all i,1≦i≦n,x∈Σ′*,Z∈Γ:

If there exists z such that xz∈Rᵢ then (q₀ᵢ,x,Z,ε) [symbol] ³*(δᵢ(q₀ᵢ,x),ε,Z,ε); and

If (q₀ᵢ,x,Z,ε) [symbol] *(p,ε,γ,v) for some p∈Q,γ∈Γ*, and v∈Δ* then p=δᵢ(q₀ᵢ,x),γ=Z,v=ε and the derivation uses type 3 moves only.

Proof. Each direction may be proved by a straightforward induction on the length of x, omitted. Q.E.D.

We can now show that each word derived from a non terminal induces a certain computation of M.

Lemma 3 For all 1≦i≦n,q∈Q,Z∈Γ and w∈L(Aᵢ)
(q,w,Z,ε) [symbol] *(δₗ(q,Aᵢ),ε,Z,π(Aᵢ [symbol] *_{L}w))
where q∈Qₗ.

Proof. We will prove the lemma by induction on the height of the derivation tree.

Basis: The height of the derivation tree is 1. Then w∈L(Aᵢ) implies that w=aᵢx₁\overline{a}ᵢ, x₁∈Σ′*, ŵ=x₁∈Rᵢ and Aᵢ→aᵢRᵢ\overline{a}ᵢ∈P. By construction of M, for all l,1≦l≦n,q∈Qₗ
(q,aᵢx₁\overline{a}ᵢ,Z,ε) [symbol] ¹(q₀ᵢ,x₁\overline{a}ᵢ,[δₗ(q,Aᵢ),aᵢ]Z,i) [symbol] ³*
(δᵢ(q₀ᵢ,x₁),\overline{a}ᵢ,[δₗ(q,Aᵢ),aᵢ]Z,i) [symbol] ²(δₗ(q,Aᵢ),ε,Z,i)
We used Lemma 2 for the middle part of the computation (type 3 moves). The last step (type 2 move) is valid since x₁∈Rᵢ implies that δᵢ(q₀ᵢ,x₁)∈Fᵢ. To complete the basis, we just note that i=π(Aᵢ [symbol] _{L}aᵢRᵢ\overline{a}ᵢ).

Induction step: Assume the lemma holds for all w′ and all i′ such that the height of the derivation tree for A_{i′} [symbol] _{L}*w′ is at most h for some h>0. Now assume Aᵢ [symbol] _{L}*w with a derivation tree of height h+1. By Lemma 1 the derivation can be rewritten as
Aᵢ [symbol] _{L}aᵢx₁Aᵢ_{₁}x₂Aᵢ_{₂} . . . xₖAᵢ_{ₖ}xₖ₊₁\overline{a}ᵢ [symbol] _{L}*aᵢx₁y₁x₂y₂ . . . xₖyₖxₖ₊₁\overline{a}ᵢ
where for each j,1≦j≦k+1,Aᵢ_{ⱼ} [symbol] _{L}*yⱼ. Furthermore, the derivation trees of all Aᵢ_{ⱼ} [symbol] _{L}*yⱼ, have height at most h, so we can use the induction hypothesis for each of them.

In order to complete the proof of the induction step, we need the following lemma:

Lemma 4. Let w=aᵢx₁y₁x₂y₂ . . . xₘyₘxₘ₊₁, such that xⱼ∈Σ′* for 1≦j≦m+1, Aᵢ_{ⱼ} [symbol] _{L}*yⱼ, for all 1≦j≦m, and assume that Lemma 3 holds for these derivations. Let ŵ=x₁Aᵢ_{₁}x₂Aᵢ_{₂} . . . xₘAᵢ_{ₘ}xₘ₊₁, and suppose there exists z such that ŵz∈Rᵢ. Then for all Z∈σ
(q,w,Z,ε) [symbol] * (δᵢ(q₀ᵢ,ŵ),ε,[δₗ(q,Aᵢ),aᵢ]Z,iπ(Aᵢ_{₁} [symbol] _{L}*y₁)π(Aᵢ_{₂} [symbol] _{L}*y₂) . . . π(Aᵢ_{ₘ} [symbol] _{L}*yₘ))

Proof. The proof will be by induction on m.

Basis: m=0. Then w=a₁x₁,ŵ=x₁∈Σ′* and there exists z such that x₁z∈Rᵢ. Then by construction, for any q∈Q,Z∈Γ, (q,aᵢx₁,Z,ε) [symbol] ¹(q₀ᵢx₁,[δₗ(q,Aᵢ),aᵢ]Z,i) where q∈Qₗ. Further, by Lemma 2 we get
(q₀ᵢ,x₁,[δₗ(q,Aᵢ),aᵢ]Z,i) [symbol] ³(δᵢ(q₀ᵢ,x₁),ε,[δₗ(q,Aᵢ),aᵢ]Z,i)
which completes the basis.

Induction step: Suppose the claim holds for all m<m₀, for some m₀>0. Now let m=m₀. Let w=aᵢx₁y₁x₂y₂ . . . xₘyₘxₘ₊1, such that xⱼ∈Σ′* for all 1≦j≦m+1, Aᵢ_{ⱼ} [symbol] _{L}*yⱼ, for all 1≦j≦m, and assume that Lemma 3 holds for these derivations. Suppose there exists z, such that ŵz∈Rᵢ where ŵ=x₁Aᵢ_{₁}x₂Aᵢ_{₂} . . . xₘAᵢ_{ₘ}xₘ₊₁. Let w₁=aᵢx₁y₁x₂y₂ . . . xₘ₋₁yₘ₋₁xₘ. By the induction hypothesis for all Z∈Γ
(q,w₁,Z,ε) [symbol] *
(δᵢ(q₀ᵢ,w₁),ε,[δₗ(q,Aᵢ),aᵢ]Z,iπ(Aᵢ_{₁} [symbol] _{L}*y₁)π(Aᵢ_{₂} [symbol] _{L}*y₂) . . . π(Aᵢ_{_{m−1}} [symbol] _{L}*yₘ₋₁))
Since w=w₁yₘxₘ₊₁, we can write
(q,w₁yₘxₘ₊₁,Z,ε) [symbol] *
(δᵢ(q₀ᵢ,ŵ₁)yₘxₘ₊₁,[δₗ(q,Aᵢ),aᵢ]Z,iπ(Aᵢ_{₁} [symbol] _{L}*y₁) . . . π(Aᵢ_{_{m−1}} [symbol] _{L}*yₘ₋₁))
We now consider derivation Aᵢ_{ₘ} [symbol] _{L}*yₘ, and use Lemma 3 to extend M's computation as follows:
(δᵢ(q₀ᵢ,ŵ₁)yₘxₘ₊₁,[δₗ(q,Aᵢ),aᵢ]Z,iπ(Aᵢ_{₁} [symbol] _{L}*y₁) . . . π(Aᵢ_{_{m−1}} [symbol] _{L}*yₘ₋₁)) [symbol] *
(δᵢ(δᵢ(q₀ᵢ,ŵ₁),Aᵢ),xₘ₊₁,[δₗ(q,Aᵢ),aᵢ]Z,iπ(Aᵢ_{₁} [symbol] _{L}*y₁) . . . π(Aᵢ_{_{m−1}} [symbol] _{L}*yₘ₋₁)π(Aᵢ_{ₘ} [symbol] _{L}*yₘ))
We now use Lemma 2 and apply the equation δᵢ(δᵢ(q,u₁),u₂)=δᵢ(q,u₁u₂) twice to extend the computation further
(δᵢ(q₀ᵢŵ₁Aᵢ),xₘ₊₁,[δₗ(q,Aᵢ),aᵢ]Z,iπ(Aᵢ_{₁} [symbol] _{L}*y₁)π(Aᵢ_{₂} [symbol] _{L}*y₂) . . . π(Aᵢ_{ₘ} [symbol] _{L}*yₘ)) [symbol] *
(δᵢ(q₀ᵢŵ₁Aᵢxₘ₊₁),ε,[δₗ(q,Aᵢ),aᵢ]Z,iπ(Aᵢ_{₁} [symbol] _{L}*y₁)π(Aᵢ_{₂} [symbol] _{L}*y₂) . . . π(Aᵢ_{ₘ}z,1_{L}*yₘ))
This establishes the entire computation, and completes the proof of the induction step. Q.E.D.

We can now complete the induction step in the proof of Lemma 3. Consider again the word w=aᵢx₁Aᵢ_{₁}x₂Aᵢ_{₂} . . . xₖAᵢ_{ₖ}xₖ₊₁\overline{a}ᵢ and the derivation
Aᵢ [symbol] _{L}aᵢx₁Aᵢ_{₁}x₂Aᵢ_{₂} . . . xₖAᵢ_{ₖ}xₖ₊₁\overline{a}ᵢ [symbol] _{L}*aᵢx₁y₁x₂y₂ . . . xₖyₖxₖ₊₁\overline{a}ᵢ
where for each j,1≦j−k+1, Aᵢ_{ⱼ} [symbol] _{L}*Yⱼ. Let w=w′\overline{a}ᵢ. Then the conditions of Lemma 4 apply to w′=aᵢx₁y₁x₂y₂ . . . xₖyₖxₖ₊₁, (with z=ε) and from the lemma we get the computation
(q,w,Z,ε) [symbol] * (δᵢ(q₀ᵢ,ŵ),\overline{a}ᵢ,[δₗ((q,Aᵢ),aᵢ]Z,iπ(Aᵢ_{₁} [symbol] _{L}*y₁)π(Aᵢ_{₂} [symbol] _{L}*y₂) . . . π(Aᵢ_{ₘ} [symbol] _{L}*yₘ))
By definition, the leftmost parse of a derivation is the production used in its first step, followed by the leftmost parses of the subtrees from left to right. Hence
iπ(Aᵢ_{₁} [symbol] _{L}*y₁)π(Aᵢ_{₂} [symbol] _{L}*y₂) . . . π(Aᵢ_{ₘ} [symbol] _{L}*yₘ))=π(Aᵢ [symbol] _{L}*w))
Also, since ŵ∈Rᵢ,δᵢ(q₀ᵢ,ŵ)∈Fᵢ, the computation may be extended by
(δᵢ(q₀ᵢ,ŵ),\overline{a}ᵢ,[δₗ(q,Aᵢ)aᵢ]Z,π(Aᵢ [symbol] _{L}*w)) [symbol] ²(δₗ(q,Aᵢ),ε,Z,π(Aᵢ [symbol] _{L}*w))
This completes the induction step and the entire proof. Q.E.D.

The next Lemma is the converse of Lemma 3.

Lemma 5. If (q,w,Z,ε) [symbol] *(p,ε,Z,v) for some q,p∈Q,Z∈Γ, and v∈Δ* so that all intermediate configurations in this computation have stack height larger than 1, then there exist i and l, such that 1≦i≦n, 0≦l ≦n, w∈L(Aᵢ), q∈Qₗ, p=δₗ(q,Aᵢ), and v=π(Aᵢ [symbol] _{L}*w).

Proof. Since all intermediate configurations in this computation have stack height larger than 1, it follows that the first step must be a type 1 move, and the last step a type 2 move. So w=aᵢx₁\overline{a}_{i′}. Let q∈Qₗ, for some 0≦l≦n. We proceed by an induction on the maximal stack height during the computation.

Basis: The maximal stack height is 2, so the computation can be written as
(q,aᵢx₁\overline{a}ᵢ,Z,ε) [symbol] ¹(q₀ᵢ,x₁\overline{a}ᵢ,[δₗ(q,Aᵢ),aᵢ]Z,i) [symbol] ³*(p₁,\overline{a}ᵢ,[δₗ(q,Aᵢ),aᵢ]Z,i) [symbol] ²(p,ε,Z,i)
where p₁′=δᵢ(q₀ᵢ,x₁) (by Lemma 2), p₁′∈Fᵢ (to allow for the type 2 move) and p=δₗ(q,Aᵢ). Clearly also i=i′. It follows that x₁∈Rᵢ, so that w=aᵢx₁\overline{a}ᵢ∈L(Aᵢ) with π(Aᵢ [symbol] _{L}*w)=i (a single step derivation). This completes the basis.

Induction step: Assume the lemma holds for computations of maximal stack height less than h, for some h>2. Now consider a computation with maximal stack height h. Since the height of the stack can be changed by at most 1 in each step, we can identify the longest subcomputations that occur at a fixed stack height of 2, and decompose the computation as follows, using the fact that moves that do not change the stack height are of type 3, which do not change the content of the stack and do not produce output. As in the basis, the left and right bracket symbols must match, so one can write w=aᵢx₁y₁x₂y₂ . . . xₖyₖxₖ₊₁\overline{a}ᵢ and decompose the computation as
(q,aᵢx₁y₁x₂y₂ . . . xₖyₖxₖ₊₁\overline{a}ᵢ,Z,ε) [symbol] ¹(p₁,x₁y₁x₂y₂ . . . xₖyₖxₖ₊₁\overline{a}ᵢ,[δₗ(q,Aᵢ),aᵢ]Z,i) [symbol] ³*
(q,aᵢx₁y₁x₂y₂ . . . xₖyₖXₖ₊₁\overline{a}ᵢ,Z,ε) [symbol] ¹(p₁,x₁y₁x₂Y₂ . . . xₖyₖxₖ₊₁\overline{a}ᵢ,[δₗ(q,Aᵢ),aᵢ]Z,i) [symbol] ³*
(p₁′,y₁x₂y₂ . . . xₖyₖxₖ₊₁\overline{a}ᵢ,[δₗ(q,Aᵢ),aᵢ]Z,i) [symbol] *(p₂,x₂y₂ . . . xₖyₖxₖ₊₁\overline{a}ᵢ,[δₗ(q,Aᵢ),aᵢ]Z,iv₁) [symbol] ³*
(p₂′,y₂ . . . xₖyₖxₖ₊₁\overline{a}ᵢ,[δₗ(q,Aᵢ)aᵢ]Z,iv₁) [symbol] ³* . . . [symbol] *(pₖ₊₁,xₖ₊₁\overline{a}ᵢ,[δₗ(q,Aᵢ),aᵢ]Z,iv₁v₂ . . . vₖ) [symbol] ³*
(pₖ₊₁′,\overline{a}ᵢ,[δₗ(q,Aᵢ),aᵢ]Z,iv₁v₂ . . . vₖ) [symbol] ²(p,ε,Z,iv₁v₂ . . . vₖ)
where intermediate configuration in the subcomputations on the words yⱼ have stack height larger than 2, so they are not dependent on the actual stack symbols. Hence we can say that for all 1≦j≦k and Z′∈Γ (pⱼ′,yⱼ,Z′,ε)*(pⱼ₊₁,ε,Z′,vⱼ), where the maximal stack height of these computations is less than h. The type 1 move (the first step in the derivation) implies that p₁=q₀ᵢ. Applying the induction hypothesis to the computations (p′ⱼ,yⱼ,Z′,ε) [symbol] *(pⱼ₊₁,ε,Z′,vⱼ) for all 1≦j≦k, we get that yⱼ∈L(Aᵢ_{ⱼ}),pⱼ′∈Qₗ_{ⱼ},pⱼ₊₁=δₗ_{ⱼ}(pⱼ′,Aᵢ_{ⱼ}),vⱼ=π(Aᵢ_{ⱼ} [symbol] _{L}*yⱼ). Looking at the type 3 subcomputations, we get from Lemma 2, that pⱼ′=δᵢ(pⱼ,xⱼ) for all 1≦j≦k. In addition, since each of the type 3 subcomputations is followed by a type 1 move (the computations on yⱼ start by increasing the size of the stack), we must have pⱼ′∈Fᵢ_{ⱼ}. By combining all the above, we can see that all lⱼ are identical, and equal to l. For all 1≦j≦k,
vⱼ=π(Aᵢ_{ⱼ} [symbol] _{L}*yⱼ).

Hence iv₁v₂ . . . vₖ=iπ(Aᵢ_{₁} [symbol] _{L}*y₁) . . . π(Aᵢ_{ₖ} [symbol] _{L}*yₖ)=π(Aᵢ [symbol] _{L}*w). Q.E.D.

Theorem 6. Given a D-grammar, one can construct a DPDT M that works as follows. For each w∈Σ*, M accepts w if and only if w∈L(A₁) . Furthermore, if w∈L(A₁), then M produces as output the left parse of w. M has no ε moves, so it running time is linear in the length of w.

Proof. Follows from Lemmas 3 and 5.

If w∈L(A₁) then by Lemma 4 (q₀₀,w,Z₀,ε) [symbol] *(f₀,ε,Z₀,π(Aᵢ [symbol] _{L}*w)), since δ₀(q₀₀,A₁)=f₀. Adding the end marker, and a type 4 move we get (q₀₀,w$,Z₀,ε) [symbol] * (f₀,$,Z₀,π(Aᵢ [symbol] _{L}*w)) [symbol] (f₀,ε,ε,π(Aᵢ [symbol] _{L}*w)). Conversely, if w$ is accepted by M, then its computation must be of the form
(q₀₀,w$,Z₀,ε) [symbol] *(f₀,$,Z₀,v) [symbol] ⁴(f₀,ε,ε,v)
We can now use Lemma 5, noting that q₀₀∈Q₀,f₀=δ₀(q₀₀,A₁) and δ₀ is undefined elsewhere, to conclude that w∈L(A₁), and v=π(A₁ [symbol] _{L}*w).

The linear running time follows from the construction of M as ε free. Q.E.D.

We can therefore construct a parser generator 20, that constructs the parsing tables 25 (a variation of the DPDT shown above) while reading DTD portion 5 of the XML file. Then parser 30 is applied to the rest 35 of the XML file, producing the leftmost parse as explained.

The size of parser 30 (the number of states) may, in the worst case, be exponential in the size of the original grammars, because the construction involves conversion of nondeterministic finite state automata to deterministic finite state automata. However, in practice, with the kind of grammars we can expect, parser 30 is not much larger than the original grammar. The running time of parser generator 20 may therefore be exponential in the worst case, but is linear in practice.

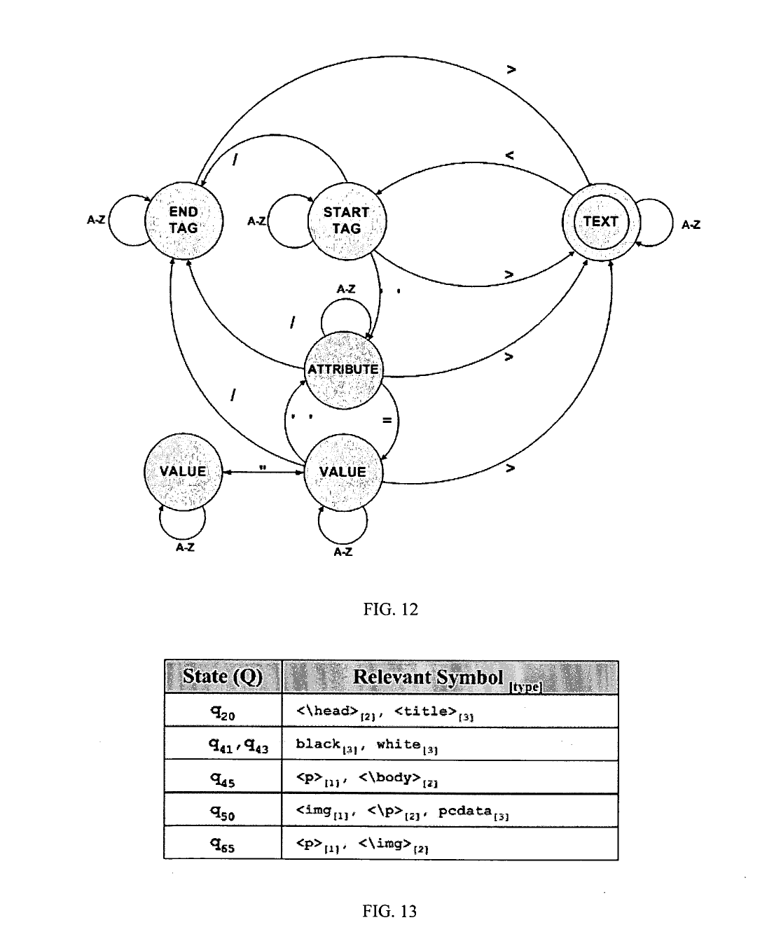

The flow in XML tokenizer 60 of FIG. 7 is described now. XML tokenizer 60 inherits its symbols table 55 from RegExp-lexer 50. The table maps symbols to XML tokens. XML tokenizer 60 reads XML source code 35 from XML source 35. It retrieves its matched lexical symbol from the symbol table 55 and sends it to XML parser 30. XML tokenizer 60 uses two types of predefined symbols: Free-text element is wrapped with the PCDATA lexical symbol, and free-text attribute-value is wrapped with the CDATA lexical symbol. FIG. 12 illustrates the XML tokenizer 60 state machine. It has five states to determine which string is currently tokenized: start tag or end tag or attribute or free text attribute value or selection list attribute value.

XML tokenizer 60 also supplies the reverse functionality. It receives a lexical symbol from the decoder and writes the matched XML token to the output XML source. In order to represent the token correctly it must know its XML entity type. The XML entity type of each symbol is inherited from RegExp-lexer 50 as part of the symbol table. The following XML representation occurs in the decoding process:

attribute: attribute =
start-element: <element>
end-element: </element>
attribute-value: “value”

We describe now the flow of XML parser 30 of FIG. 7. The DPDT generated as described above is applied to the stream of XML tokens 65, producing the leftmost parse as explained. Since the DPDT has no ε moves, it works in linear time. (It is similar to the operation of a LL parser—working top down, with no backtracking). As noted above, the output of the DPDT is the left parse of the input word, namely a list of the production numbers used in the parse tree, listed top down, left to right. However, for the purpose of the encoding, a different output is needed, as will be explained immediately.

DPDT-guided encoding encodes lexical symbols. Encoding lexical symbols is a more natural approach than encoding production rules (as in LL-guided-parser encoding). It overcomes the basic problems of LL-guided-parser encoding: order-inflation and redundant-categorization, but it maintains LL-guided-parser encoding top-down manner.

Two types of LL-guided-parser encodings are described above in the Background section:
1. global encoding: encodes all the production rules together in the underlying coder.
2. local encoding: encodes the relevant production rules. Relevant production rules are the ones that can derive the non-terminal at the top of the stack.

DPDT-guided encoding replaces the production rules by lexical symbols. Global DPDT-guided encoding encodes all the lexical symbols together in the underlying coder. It means it does not use the parsing process information. It just encodes the lexical information. Local DPDT-guided encoding encodes only the lexical symbols that are relevant for the current DPDT state. The relevant lexical symbols are determined by the DPDT transition function. Each transition type reflects a symbol relevancy-type. The DPDT-guided encoder constructs a relevant-symbol table as follows:
Type 1: For all 1≦i≦n, 0≦j≦n and q∈Qⱼ, if δⱼ(q,Aᵢ) is defined, then aᵢ is relevant to q (left bracket).
Type 2: For all 1≦i≦n and q∈Fᵢ, \overline{a}ᵢ is relevant to q (right bracket).
Type 3: For all 0≦i≦n, q∈Qᵢ, a∈Σ′ if δᵢ(q,a) is defined, then a is relevant to q (non bracket symbol).

States that have a single relevant symbol are ignored by the encoding algorithm and are not inserted to the table. In the XHTML example the relevant symbol table is shown in FIG. 13. It is constructed from the regular-expressions of FIG. 10. For each state, the list of relevant symbols is detailed. The angled brackets to the right of each symbol mark its relevancy type.

When encoding the XHTML example of FIG. 2 we receive the following encoded local encoded symbols, as shown in FIG. 11:
Encoded symbols: -, -, </head>, -, -, . . . , -, <p>, “don't be”, <img, . . . , -, -, </p>, </body >, -
   The ‘-’ character marks deterministic lexical-symbols that are ignored by the encoder.
   The ‘ . . . ’ marks the places in the example where details of the parsing were not shown.

Implementation of a local-DPDT encoding by PPM is straightforward. PPM uses an exclusion bit mask that refers to the symbols that are excluded during a symbol encoding. Normally, PPM initializes an empty exclusion mask for every new encoded symbol. In local DPDT-encoding we use the relevant symbol table to mask the non-relevant symbols and initializes PPM with the exclusion mask. Thus, the PPM encoder ignores the non-relevant symbols and encodes only the relevant symbols.

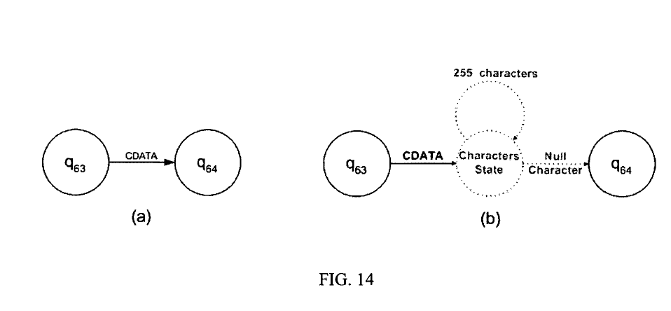

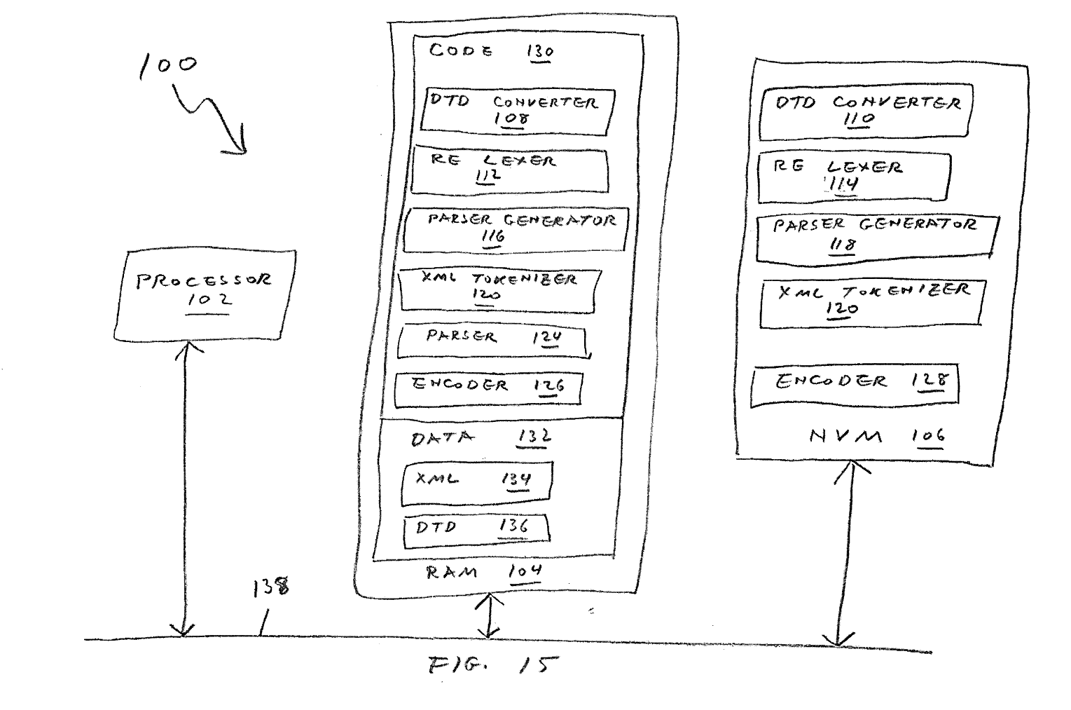

XML documents contain a mixture of free text (content) and formatted text (structure). Our encoding algorithm encodes both content and structure in the same stream. The algorithm adds to the DPDT transition function virtual transitions that accept the content. Content characters are treated as lexical symbols. Each character has a local transition with the characters state. A special terminator character is added to refer to the end of the content. Otherwise, the next lexical symbol can be missed. FIG. 14 illustrates content handling. FIG. 14A shows the original attributes' value transition, of the img element (see FIG. 10). FIG. 14B shows how the characters state is added to the img element FSA in order to encode the CDATA content.

### XML Compression Results

Our algorithm was tested on a XML corpus with a wide range of distinct structural characteristics. It is based on XML corpus from well known XML encoding experiments, especially the XMill corpus of Liefke and Suciu. We call this corpus the “XML corpus”.

The following Table 1 shows the characteristics of the benchmark files. Column 2 (Size) is the size of the dataset. How many characters in the dataset are XML tags characters (in percentage) is given in column 3 (Structure). The average depth of the stack (XML tree) in our parser is given in column 4 (Average depth). This statistic is gathered by our algorithm during the parsing of the XML documents. The average number of relevant symbols also is measured (Average freedom) and given in column 5. “Relevant” symbols are symbols that are accepted by the outgoing transitions from the current parser state in the prediction-NFA.

| | | Structure | Average | Average |
|---|---|---|---|---|
| Document | Size | (%) | depth | freedom |
| stats | 671,949 | 89 | 5 | 19 |
| periodic | 112,986 | 78 | 2 | 3 |
| spec | 220,674 | 30 | 7 | 33 |
| weblog | 2,295 | 63 | 2 | 2 |
| dblp | 702,557 | 48 | 2 | 13 |
| play | 260,891 | 44 | 4 | 4 |
| tpc | 299,407 | 71 | 3 | 2 |

The XML corpus contains seven documents. Here we describe the characteristics of these documents (datasets):

Stats This document contains football statistics. It describes the players of all teams in a certain year.

periodic This document describes the periodic table in XML format. The characteristics of each atom (name, atomic weight, etc.) are given.

spec This document is a W3C example of XHTML. The document is a web documentation of the XHTML standard as appears in the W3C web site.

weblog This document contains information about HTTP requests to a WEB server. This includes information like host IP number, URL address and the size of the reply packet.

dblp This document is a database and logic programming that contains bibliographical references for databases and logic programming research. The underlying data are stored in plain XML files.

play This document is taken from the Shakespeare XML database. It is a collection of Shakespeare lyrics that were converted into XML.

tpc Benchmark tests are a popular mechanism for evaluating the query and update performance of databases. The TPC-D benchmark is based on databases that models suppliers, items, lines, customers, countries, etc. Altogether, the TPC-D benchmark contains eight relations.

We compare our global (DPDT-G) and local (DPDT-L) encoding schemes with the existing methods with the available compression tools: Xmill and Xmlppm. We also compare it to PPMD+, which is the basic encoder that operates in our encoding algorithm. The following Table 2 summarizes the compression ratios (CR) of different methods.

| Document | DPDT-L | DPDT-G | Xmlppm | PPM | Xmill |
|---|---|---|---|---|---|
| Stat | 23.651 | 22.939 | 25.567 | 13.569 | 18.929 |
| periodic | 24.324 | 22.298 | 21.566 | 14.297 | 18.995 |
| spec | 5.951 | 5.811 | 5.811 | 5.557 | 4.072 |
| weblog | 5.961 | 5.288 | 4.636 | 4.250 | 3.806 |
| dblp | 8.575 | 8.480 | 8.365 | 7.944 | 6.516 |
| play | 5.583 | 5.564 | 5.567 | 5.262 | 4.065 |
| tpc | 7.736 | 7.411 | 7.715 | 6.046 | 7.355 |

In order to compare two compression methods, “A” and “B” with their encoded document file sizes (|A| and |B|), we use the formula

$$( \frac{\vert A \vert}{\vert B \vert} - 1 ) * 100.$$

This equation evaluates the improvement in percentage in the compression of method “A” over method “B”. If this relation is greater than 0, then method “A” achieves higher compression ratio than method “B”.

The results in table 2 clearly shows that local DPDT encoded-guided-parser (DPDT-L) outperforms the rest. The Xmlppm method is the second best. The DPDT-L is on the average better by 5% over the Xmlppm CR. In the best case compression scenario of Xmlppm (“weblog” dataset), DPDT-L improves the CR by 25%. There is a single exception when Xmlppm is doing better than DPDT-L in the “stat” document.

Our XML DPDT encoded-guided compression algorithm is the only method that is based on syntactic analysis of the structure of the XML. Therefore, we expect to achieve much higher CR on XML structure encoding. In order to do so we reconstruct the XML corpus by removing all its content. Thus, we create the XML structure corpus. Then we repeat the experiment of Table 2 on the XML structure corpus. The following Table 3 summarizes the CR for the XML structure corpus.

| Document | DPDT-L | DPDT-G | Xmlppm | PPM | Xmill |
|---|---|---|---|---|---|
| stat | 2323.754 | 1105.727 | 471.006 | 28.721 | 503.283 |
| periodic | 527.108 | 115.445 | 194.833 | 24.898 | 27.692 |
| spec | 33.468 | 26.567 | 29.558 | 15.639 | 29.473 |
| weblog | 156.364 | 45.263 | 16.226 | 10.617 | 11.622 |
| dblp | 209.248 | 173.486 | 256.4977 | 47.825 | 178.875 |
| play | 152.257 | 128.626 | 125.627 | 32.732 | 75.415 |
| tpc | 630.804 | 137.292 | 233.825 | 14.329 | 158.773 |

The superiority of the DPDT-L in table 3 is evident. It is 2.1 times better on the average than Xmlppm. The “stats” source provides the best case compression scenario for DPDT-L. DPDT-L is five times better than Xmlppm. It is a surprising result because the best compression method on the “stat” source is Xmlppm. This is the only case where Xmlppm outperforms DPDT-L.

The single case in which Xmlppm compresses document better than DPDT-L is the “dblp” dataset (by 20%). The improvement is explained by the different structure encoding method. Xmlppm splits the structure encoding to element and attributes. In the “dblp” document there is a single attribute, “key”, that appears again and again. This is a special case in which split encoding actually helps.

We now analyze which content encoding method fits best for XML compression. Basically, there are two content encoding methods:

Separation: separates between content and structure encoding.

Unification: unifies content and structure encoding.

The following table 4 summarizes the achieved CR for the two content encoding methods separation and unification. Table 4 compares content compression methods for the following XML encoders: DPDT-G, DPDT-L and PPM. The postfix ‘-S’ is added to identify that this is a separation based content encoding method. The postfix ‘-U’ is added to identify that this is a unification based content encoding method.

| | DPDT- | DPDT- | DPDT- | DPDT- | | |
|---|---|---|---|---|---|---|
| Document | L-U | L-S | G-U | G-S | PPM-U | PPM-S |
| stat | 23.651 | 25.566 | 22.939 | 25.295 | 13.569 | 14.376 |
| periodic | 24.324 | 23.394 | 22.298 | 21.314 | 14.297 | 9.74 |
| spec | 5.951 | 5.864 | 5.811 | 5.791 | 5.557 | 5.557 |
| weblog | 5.961 | 5.9 | 5.288 | 5.543 | 4.25 | 4.25 |
| dblp | 8.575 | 8.401 | 8.480 | 8.368 | 7.944 | 7.894 |
| play | 5.583 | 5.514 | 5.564 | 5.5 | 5.262 | 5.255 |
| tpc | 7.736 | 7.605 | 7.411 | 7.716 | 6.046 | 6.546 |

The results of table 4 show that for DPDT-L encoding, unification is better than separation. The best CR was achieved for the “dblp” document (2% CR improvement). This is the only “structural” case where our DPDT-L algorithm achieves less compression than Xmlppm. It suggests that what counts most in XML compression is the content. Structure encoding can only assist in content encoding.

There is one exception to the unification superiority. Content separation is better than unification when the “stat” document is used. It explains why Xmlppm is better then DPDT-L for the “stat” document (see table 2), although the “stat” structure is encoded 4.5 times better by DPDT-L. It is because Xmlppm separates structure and content whereas DPDT-L unifies it. Again we witness the fact that content encoding is more important than structural encoding.

There is no clear results for the G-DPDT and PPM encoders.

### Implementation

FIG. 15 is a partial high-level block diagram of a system 100 for implementing the present invention. The major components of system 100 that are illustrated in FIG. 15 are a processor 102, a random access memory (RAM) 104 and a non-volatile memory (NVM) 106 such as a hard disk. Processor 102, RAM 104 and NVM 106 communicate with each other via a common bus 138. Not shown in FIG. 15 are conventional input and output devices, such as a compact disk drive, a USB port, a monitor, a keyboard and a mouse, that also communicate via bus 138.

NVM 106 has embodied thereon source code 110 for a DTD converter of the present invention, source code 114 for a regular expression lexical analyzer, source code 118 for a parser generator of the present invention, source code 120 for an XML tokenizer and source code 128 for a PPM encoder. This source code is coded in a suitable high-level language. Selecting a suitable high-level language is easily done by one ordinarily skilled in the art. The language selected should be compatible with the hardware of system 100, including processor 102, and with the operating system of system 100. Examples of suitable languages include but are not limited to compiled languages such as FORTRAN, C and C++. Note that the source code modules of NVM 106 correspond to the functional blocks of FIG. 7 except XML parser 30. NVM 106 is an example of a computer readable storage medium on which is embodied program code of the present invention.

Processor 102 compiles source code 110, 114, 118, 120 and 128 to produce corresponding machine code that is stored in corresponding subregions 108, 112, 116, 120 and 126 of a code storage region 130 of RAM 104. (Reference numerals 108, 112, 116, 120, 124 and 126 are used herein to refer both to machine code and to the subregions of code storage region 130 of RAM 104 where that machine code is stored.)

XML source code to be compressed, and the associated DTD, are introduced to system 100 in the conventional manner. The XML source code is stored in a subregion 134 of a data storage region 132 of RAM 104. The DTD is stored in a subregion 136 of data storage region 132 of RAM 104. Using the DTD from subregion 136 as input, processor 102 executes machine code 108, 112 and 116 to implement functional blocks 10, 50 and 20, respectively, of FIG. 7, thereby generating machine code, corresponding to “XML parser” functional block 30 of FIG. 7, that is stored in a subregion 124 of code storage region 130 of RAM 104. Then, using the XML source code from subregion 136 as input, processor 102 executes machine code 120, 124 and 126 to implement functional blocks 60, 30 and 40, respectively, of FIG. 7, thereby compressing the XML source code from subregion 136.

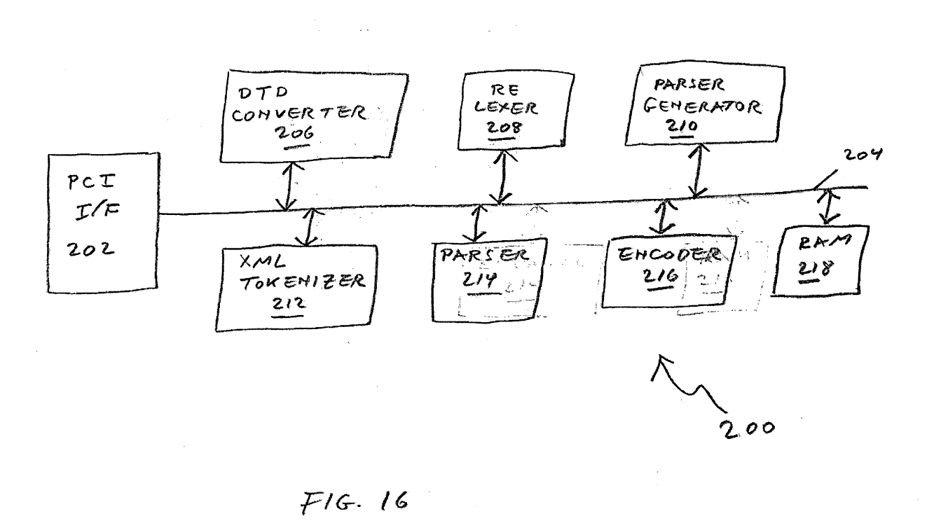

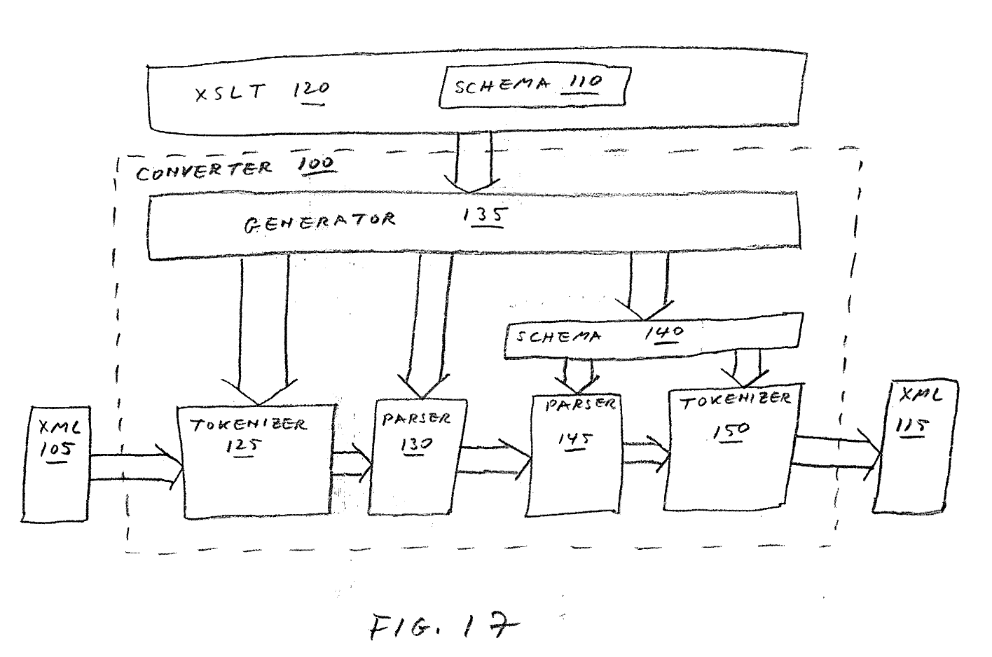

FIG. 16 is a partial high-level block diagram of a hardware implementation of the present invention, specifically, a PCI card 200. The major components of PCI card 200 that are illustrated in FIG. 16 are a standard 47-pin PCI interface, six dedicated processors 206, 208, 210, 212, 214 and 216, and a RAM 218, all communicating with each other via a local bus 204. Dedicated processors 206, 208, 210, 212, 214 and 216 are, for example, application-specific integrated circuits (ASICs) or field programmable gate arrays (FPGAs). Dedicated processor 206 is a DTD converter that implements the DTD conversion of block 10 of FIG. 7. Dedicated processor 208 is a RegExp-lexer that implements the RE lexical analysis of block 50 of FIG. 7. Dedicated processor 210 is a parser generator, corresponding to block 20 of FIG. 7, that generates parse table 25 of FIG. 7. Dedicated processor 212 is an XML tokenizer, corresponding to block 60 of FIG. 7, that tokenizes input XML source code 35. Dedicated processor 214 is a generic parser that corresponds to block 30 of FIG. 7. Dedicated processor 216 is an encoder that implements the encoding of block 40 of FIG. 7.

Plugging PCI card 200 into the PCI bus of a standard personal computer provides that personal computer with a fast, hardware-based implementation of the functionality of the present invention. Those skilled in the art will readily conceive of analogous hardware implementations of the present invention that are suitable for incorporation in, for example, smart cards, personal data assistants and cellular telephones.

FIG. 17 is a flow chart of a converter 100 of the present invention that converts an input XML document 105 to an output XML document 115 under the guidance of an XSLT document 120 that includes the schema 110 of XML document 105. An input tokenizer 125 and an input parser 130 of the present invention receive schema 110 from XSLT document 120 via a schema generator 135 and parse input XML document 105 much as illustrated for DTD 5 and XML document 35 in FIG. 7. Schema generator 135 also creates a schema 140 for output XML document 115. An output parser 145 of the present invention and an output tokenizer 150 convert the output of parser 130 to output XML document 115 as guided by schema 140. Although FIG. 17 shows only one input parser 130 and only one output parser 145, those skilled in the art will appreciate that converter 100 also could be configured with two or more input parsers in series and/or with two or more chained output parsers in series.

### Applications

The fast XML parser of the present invention improves the performance of the XML devices described in the Background section above: validators, converters and editors. One important application of an XML converter is for translating Structured Query Language (SQL) source code to and from XML. SQL is the accepted standard language for querying structured databases, but, as noted above, XML is the de facto standard for Web-based application. A database server that receives queries in XML must translate the queries to SQL and then must translate the SQL answers to XML.

Other devices whose performance is accelerated by the fast XML parsing of the XML parser of the present invention include network routers, network switches, network security gateways and network managers such as network security/management agents. Absent the acceleration provided by the present invention, a network node such as a router or a switch may be a bottleneck when the XML traffic load on the network is heavy. Prior art network security gateways and network security/management agents are available, e.g., from Sarvega of Oakbrook Terrace Ill., USA. These Sarvega products are described in three white papers, Sarvega Guardian Products White Paper, Maximizing the Reliability and Security of Web Services, and Sarvega XML Guardian Gateway White Paper, that are available at the Sarvega web site, http://www.sarvega.com, and that are incorporated by reference for all purposes as if fully set forth herein. The third white paper describes the need for fast parsing in the context of network security as follows:
Security functions such as XML Digital Signatures—signing and verification, XML encryption and decryption, XML Schema verification, XML Transformation and Xpath filtering—are computationally expensive. To process XML data for security, fast parsing, transformation and Xpath evaluation are necessary. A typical XML security transaction—which involves parsing, schema validation, Xpath evaluation, transformation, decryption, and signature verification—takes as much as 70% of its processing time processing XML, instead of crypto processing. This additional, and often unpredictable, processing burden can significantly increase latency and lower throughput.
   Note that the “parsing” of the present invention includes both what the above passage from the third white paper calls “parsing” and what the above passage from the third white paper calls “schema validation”.

Fast XML parsing also finds applications in network management, particularly in ensuring quality of service. For example, the second white paper describes the benefits of integrating a network security gateway with network security/management agents as follows:
An XML gateway and an agent-based management system overlap with respect to XML parsing, WS-security token processing, security policy administration, and service reliability. Pursuing integration between the XML gateway and the management system can result in new efficiencies around these mechanisms.
   One quality-of-service scenario in which an XML gateway would benefit from access to a parser of the present invention, whether or not the gateway uses network management agents, is the following. Wireless Application Protocol (WAP) is an XML-based protocol for exchanging data between a network such as the Internet and handheld devices such as cellular telephones. A “Goal On Demand” web server typically communicates with the client handheld devices that subscribe to its service via an XML gateway and a WAP gateway. The XML gateway needs to monitor the quality of its service to ensure that the subscribers receive the quality of service to which they are entitled. Such an XML gateway benefits from using the fast parser of the present invention as part of reading the XML packets that traverse the gateway to identify the subscriber destinations of the packets, as part of monitoring the quality of service that the gateway provides.

Clients (end-user devices) that communicate with the Internet under the WAP protocol benefit similarly from the use of a parser of the present invention. In addition to cellular telephones, examples of such clients include personal data assistants, smart cards and digital entertainment systems similar to the iPod digital music player (Apple Computer, Inc., Cupertino Calif., USA) and the PlayStation video game console (Sony Corporation, Tokyo, Japan).

While the invention has been described with respect to a limited number of embodiments, it will be appreciated that many variations, modifications and other applications of the invention may be made.

What is claimed is:

1. A method of generating a parser of a source code file that references a syntactic dictionary for the source code, comprising the steps of:
(a) converting the syntactic dictionary into a corresponding plurality of expressions of a context-free grammar, said expressions being a grammar of the source code of the file; and
(b) constructing the parser from said expressions.

2. The method of claim 1, wherein said expressions are regular expressions.

3. The method of claim 1, wherein said context-free grammar is a Backus-Naur-Form context-free grammar.

4. The method of claim 3, wherein said Backus-Naur-Form context-free grammar is equivalent to a D-grammar.

5. The method of claim 1, wherein said context-free grammar is an Extended Backus-Naur-Form context-free grammar.

6. The method of claim 5, wherein said Extended Backus-Naur-Form context-free grammar is equivalent to a D-grammar.

7. The method of claim 1, wherein said grammar of the source code of the file is a D-grammar.

8. The method of claim 1 wherein the parser is a deterministic pushdown transducer.

9. A computer readable storage medium having computer readable code embodied on said computer readable storage medium, the computer readable code for generating a parser of a source code file that references a syntactic dictionary for the source code, the computer readable code comprising:
(a) program code for converting the syntactic dictionary into a corresponding plurality of expressions of a context-free grammar, said expressions being a grammar of the source code of the file; and
(b) program code for constructing the parser from said expressions.

10. A method of compressing a file that includes source code and that references a syntactic dictionary for the source code, the syntactic dictionary including at least one attribute definition, the method comprising the steps of:
(a) converting the syntactic dictionary into a corresponding plurality of expressions of a context-free grammar, said expressions being a grammar of the source code of the file;
(b) constructing a parser of the source code from said expressions; and
(c) compressing the source code using said parser.

11. The method of claim 10, wherein said expressions are regular expressions.

12. The method of claim 10, wherein said context-free grammar is a Backus-Naur-Form context-free grammar.

13. The method of claim 12, wherein said Backus-Naur-form context-free grammar is equivalent to a D-grammar.

14. The method of claim 10, wherein said context-free grammar is an Extended Backus-Naur-Form context-free grammar.

15. The method of claim 14, wherein said Extended Backus-Naur-Form context-free grammar is equivalent to a D-grammar.

16. The method of claim 10, wherein said grammar of the source code of the file is a D-grammar.

17. The method of claim 10, wherein said parser is a deterministic pushdown transducer.

18. The method of claim 10, wherein said compressing of the source code is based at least in part on the at least one attribute definition.

19. The method of claim 10, wherein said compressing of said source code is effected by steps including tokenizing the source code to produce a plurality of tokens that are input to said parser.

20. The method of claim 19, wherein, for each said token, said parser produces a left parse of said token.

21. The method of claim 19, wherein said compressing of the source code includes local encoding of each said token guided by said parser.

22. A method of transmitting, from a transmitter to a receiver, a file that includes source code and that references a syntactic dictionary for the source code, the method comprising the steps of:
(a) at the transmitter and at the receiver:
(i) converting the syntactic dictionary into a corresponding plurality of expressions of a context-free grammar, said expressions being a grammar of the source code of the file, and
(ii) constructing a parser of the source code from said expressions;
(b) at the transmitter, processing the source code using said parser that is constructed at the transmitter; and
(c) at the receiver, recovering the source code from output of said processing, using said parser that is constructed at the receiver.

23. The method of claim 22, wherein said processing includes compressing the source code, thereby producing compressed source code; and wherein said recovering includes decompressing said compressed source code.

24. A method of compressing a file that includes source code and that references a syntactic dictionary for the source code, the source code including both structure and contents, the method comprising the steps of:
(a) converting the syntactic dictionary into a corresponding plurality of expressions of a context-free grammar, said expressions being a grammar of the source code of the file;
(b) constructing a parser of the source code from said expressions; and
(c) compressing the source code using said parser;
wherein said compressing of the source code encodes both the structure and the content in a single common stream.

25. A computer readable storage medium having computer readable code embodied on said computer readable storage medium, the computer readable code for compressing a file that includes source code and that references a syntactic dictionary for the source code, the computer readable code comprising:
(a) program code for converting the syntactic dictionary into a corresponding plurality of expressions of a context-free grammar, said expressions being a grammar of the source code of the file;
(b) program code for constructing a parser of the source code from said regular expressions; and
(c) program code for compressing the source code using said parser.

26. A computer readable storage medium having computer readable code embodied on said computer readable storage medium, the computer readable code for decompressing compressed source code produced by the computer readable code of claim 25, the computer readable code comprising program code for decompressing the compressed source code using said parser.

27. A computer readable storage medium having computer readable code embodied on said computer readable storage medium, the computer readable code for compressing a file that includes source code and that references a syntactic dictionary for the source code, the source code including both structure and contents, the computer readable code comprising:
(a) program code for converting the syntactic dictionary into a corresponding plurality of expressions of a context-free grammar, said expressions being a grammar of the source code of the file;
(b) program code for constructing a parser of the source code from said expressions; and
(c) program code for compressing the source code using said parser;
wherein said compressing of the source code encodes both the structure and the content in a single common stream.

28. An apparatus for parsing a source code file that references a syntactic dictionary for the source code, comprising:
(a) a dictionary converter for converting the syntactic dictionary into a corresponding plurality of expressions of a context-free grammar, said expressions being a grammar of the source code of the file;
(b) a parser generator for creating at least one parse table for the source code from said expressions; and
(c) a parser for parsing the source code according to said at least one parse table.

29. A source code compressor comprising the apparatus of claim 28.

30. The source code compressor of claim 29, wherein the apparatus further comprises:
(d) a lexical analyzer for:
(i) tokenizing said expressions, thereby producing a plurality of syntactic dictionary tokens; and
(ii) transforming each said syntactic dictionary token to a corresponding lexical symbol; said parser generator then creating said at least one parse table from said lexical symbols.

31. The source code compressor of claim 30, wherein the apparatus further comprises:
(e) a source language tokenizer for tokenizing the source code in accordance with said lexical symbols, thereby producing a plurality of source code tokens, said parser then parsing said source code tokens.

32. The source code compressor of claim 29, wherein the apparatus further comprises:
(d) an encoder for encoding output of said parser.

33. A source code decompressor comprising the apparatus of claim 28.

34. A source code validator comprising the apparatus of claim 28.

35. A source code converter comprising the apparatus of claim 28.

36. A source code editor comprising the apparatus of claim 28.

37. A network device comprising the apparatus of claim 28.

38. The network device of claim 37, selected from the group consisting of a network router, a network switch, a network security gateway and a network manager.

39. The network device of claim 37, wherein the network device uses the apparatus of claim 28 to monitor quality of service.

40. An end-user device comprising the apparatus of claim 28.

41. The end-user device of claim 40, selected from the group consisting of a personal computer, a personal data assistant, a cellular telephone and a smart card.

42. The end-user device of claim 40, wherein the end-user device is a hand-held device.

43. A method of generating a parser of an XML file that includes XML code and that references a syntactic dictionary for the XML code, comprising the steps of:
(a) converting the syntactic dictionary into a corresponding plurality of expressions of a context-free grammar, said expressions being a grammar of the XML code of the file; and
(b) constructing the parser from said expressions.

44. The method of claim 43 wherein said expressions are regular expressions.

45. The method of claim 43, wherein said context-free grammar is a Backus-Naur-Form context-free grammar.

46. The method of claim 45, wherein said Backus-Naur-Form context-free grammar is equivalent to a D-grammar.

47. The method of claim 43, wherein said context-free grammar is an Extended Backus-Naur-Form context-free grammar.

48. The method of claim 47, wherein said Extended Backus-Naur-Form context-free grammar is equivalent to a D-grammar.

49. The method of claim 43, wherein said grammar of the XML code of the file is a D-grammar.

50. The method of claim 43, wherein the parser is a deterministic pushdown transducer.

51. A computer readable storage medium having computer readable code embodied on said computer readable storage medium, the computer readable code for generating a parser of a XML file, the XML file including XML code and referencing a syntactic dictionary for the XML code, the computer readable storage medium comprising:
(a) program code for converting the syntactic dictionary into a corresponding plurality of expressions of a context-free grammar, said expressions being a grammar of the XML code of the file; and
(b) program code for constructing the parser from said expressions.

52. A method of compressing a XML file that includes XML code and that references a syntactic dictionary for the XML code, the syntactic dictionary including at least one attribute definition, the method comprising the steps of:
(a) converting the syntactic dictionary into a corresponding plurality of expressions of a context-free grammar, said expressions being a grammar of the XML code of the file;
(b) constructing a parser of the XML code from said regular expressions; and
(c) compressing the XML code using said parser.

53. The method of claim 52, wherein said expressions are regular expressions.

54. The method of claim 52, wherein said context-free grammar is a Backus-Naur-Form context-free grammar.

55. The method of claim 54, wherein said Backus-Naur-Form context-free grammar is equivalent to a D-grammar.

56. The method of claim 52, wherein said context-free grammar is an Extended Backus-Naur-Form context-free grammar.

57. The method of claim 56, wherein said Extended Backus-Naur-Form context-free grammar is equivalent to a D-grammar.

58. The method of claim 52, wherein said grammar of the XML code of the file is a D-grammar.

59. The method of claim 52, wherein said parser is a deterministic pushdown transducer.

60. The method of claim 52, wherein said compressing of the XML code is based at least in part on the at least one attribute definition.

61. The method of claim 52, wherein said compressing of said XML code is effected by steps including tokenizing the XML code to produce a plurality of tokens that are input to said parser.

62. The method of claim 61, wherein, for each said token, said parser produces a left parse of said token.

63. The method of claim 61, wherein said compressing of the XML code includes local encoding of each said token guided by said parser.

64. A method of transmitting, from a transmitter to a receiver, a XML file that includes XML code and that references a syntactic dictionary for the XML code, the method comprising the steps of:
(a) at the transmitter and at the receiver:
(i) converting the syntactic dictionary into a corresponding plurality of expressions of a context-free gram-mar, said expressions being a grammar of the source code of the file, and
(ii) constructing a parser of the XML code from said expressions;
(b) at the transmitter, processing the source code using said parser that is constructed at the transmitter; and
(c) at the receiver, recovering the source code from output of said processing, using said parser that is constructed at the receiver.

65. The method of claim 64, wherein said processing includes compressing the source code, thereby producing compressed source code, and wherein said recovering includes decompressing said compressed source code.

66. A method of compressing a XML file that includes XML code and that references a syntactic dictionary for the XML code, the XML code including both structure and contents, the method comprising the steps of:
(a) converting the syntactic dictionary into a corresponding plurality of expressions of a context-free grammar, said expressions being a grammar of the XML code of the file;
(b) constructing a parser of the XML code from said expressions; and
(c) compressing the XML code using said parser;
wherein said compressing of the XML code encodes both the structure and the content in a single common stream.

67. A computer readable storage medium having computer readable code embodied on said computer readable storage medium, the computer readable code for compressing a XML file, the XML file including XML code and referencing a syntactic dictionary for the XML code, the computer readable code comprising:
(a) program code for converting the syntactic dictionary into a corresponding plurality of expressions of a context-free grammar, said expressions being a grammar of the XML code of the file;
(b) program code for constructing a parser of the XML code from said expressions; and
(c) program code for compressing the XML code using said parser.

68. A computer readable storage medium having computer readable code embodied on said computer readable storage medium, the computer readable code for decompressing compressed XML code produced by the computer readable code of claim 67, the computer readable code comprising program code for decompressing the compressed XML code using said parser.

69. A computer readable storage medium having computer readable code embodied on said computer readable storage medium, the computer readable code for compressing a XML file, the XML file including XML code and referencing a syntactic dictionary for the XML code, the XML code including both structure and contents, the computer readable code comprising:
(a) program code for converting the syntactic dictionary into a corresponding plurality of expressions of a context-free grammar, said expressions being a grammar of the XML code of the file;
(b) program code for constructing a parser of the XML code from said expressions; and
(c) program code for compressing the XML code using said parser;
wherein said compressing of the source code encodes both the structure and the content in a single common stream.

70. An apparatus for parsing an XML file that includes XML code and that references a syntactic dictionary for the XML code, comprising:
(a) a dictionary converter for converting the syntactic dictionary into a corresponding plurality of expressions of a context-free grammar, said expressions being a grammar of the XML code of the file;
(b) a parser generator for creating at least one parse table for the XML code from said expressions; and
(c) a parser for parsing the XML code according to said at least one parse table.

71. A XML code compressor comprising the apparatus of claim 70.

72. The XML code compressor of claim 71, wherein the apparatus further comprises:
(d) a lexical analyzer for:
(i) tokenizing said expressions, thereby producing a plurality of syntactic dictionary tokens; and
(ii) transforming each said syntactic dictionary token to a corresponding lexical symbol; said parser generator then creating said at least one parse table from said lexical symbols.

73. The XML code compressor of claim 72, wherein the apparatus further comprises:
(e) a XML tokenizer for tokenizing the XML code in accordance with said lexical symbols, thereby producing a plurality of XML tokens, said parser then parsing said XML tokens.

74. The XML code compressor of claim 71, wherein the apparatus further comprises:
(d) an encoder for encoding output of said parser.

75. A XML code decompressor comprising the apparatus of claim 70.

76. A XML code validator comprising the apparatus of claim 70.

77. A XML code converter comprising the apparatus of claim 70.

78. A XML code editor comprising the apparatus of claim 70.

79. A network device comprising the apparatus of claim 70.

80. The network device of claim 79, selected from the group consisting of a network router, a network switch, a network security gateway and a network manager.

81. The network device of claim 79, wherein the network device uses the apparatus of claim 70 to monitor quality of service.

82. An end-user device comprising the apparatus of claim 70.

83. The end-user device of claim 82, selected from the group consisting of a personal computer, a personal data assistant, a cellular telephone and a smart card.

84. The end-user device of claim 82, wherein the end-user device is a hand-held device.
